(19) United States
(12) Patent Application Publication
(10) Pub. No.: US 2010/0143693 A1
(43) Pub. Date: Jun. 10, 2010

(54) CRYSTALLINE 3D- AND 2D COVALENT ORGANIC FRAMEWORKS

(75) Inventors: Omar M. Yaghi, Los Angeles, CA (US); Adrien P. Cote, Los Angeles, CA (US); Hani M. El-Kaderi, Midlothian, VA (US); Joseph R. Hunt, Fredericksburg, VA (US)

Correspondence Address: Joseph R. Baker, APC;Gavrilovich, Dodd & Lindsey LLP, 4660 La Jolla Village Drive, Suite 750, San Diego, CA, 92122, US

(73) Assignee: THE REGENTS OF THE UNIVERSITY OF CALIFORNIA, Oakland, CA (US)

(21) Appl. No.: 12/524,205

(22) PCT Filed: Jan. 24, 2008
(86) PCT No.: PCT/US2008/051859

§ 371 Date: Feb. 25, 2010

Related U.S. Application Data
(60) Provisional application No. 60/886,499, filed on Jan. 24, 2007.
(60) Provisional application No. 60/950,318, filed on Jul. 17, 2007.

(51) Int. Cl. B32B 3/26

(52) U.S. Cl. 428/305.5; 428/304.4

(57) ABSTRACT

The disclosure relates generally to materials that comprise organic frameworks. The disclosure also relates to materials that are useful to store and separate gas molecules and sensors.

### CROSS-REFERENCE TO RELATED APPLICATIONS

This application claims priority under 35 U.S.C. §119 to U.S. Provisional Application Ser. Nos. 60/886,499, filed Jan. 24, 2007, and 60/950,318, filed Jul. 17, 2007, both of which are incorporated herein by reference.

### TECHNICAL FIELD

The application relates generally to materials that comprised organic frameworks. The application also relates to materials that are useful to store and separate gas molecules, as well as sensors based upon the frameworks.

### BACKGROUND

There has been an increasing demand for porous materials in industrial applications such as gas storage, separations, and catalysis. Some advantages of using completely organic porous materials as opposed to their inorganic or metal-organic counterparts, are that organic materials are lighter in weight, more easily functionalized, and have the potential to be more kinetically stable. In addition, there are environmental advantages to employing extended structures without metal components.

Some current methods of inducing porosity within polymers involve various processing methods or preparation from colloidal systems. All glassy polymers contain some void space (free volume), although this is usually less than 5% of the total volume. It is possible to “freeze-in” up to 20% additional free volume for some glassy polymers with rigid structures by rapid cooling from the molten state below the glass transition temperature, or by rapid solvent removal from a swollen glassy polymer. High free volume polymers are currently used in industrial membranes for transporting either gases or liquids. The voids in these materials, however, are not interconnected and therefore reflect a low accessible surface area as determined by gas adsorption. Moreover, the pore structure is irregular and not homogeneous.

Another existing class of porous organic materials includes polyacetylenes containing bulky substituent groups. The high gas permeabilities of poly(1-trimethylsilyl-1-propyne) (“PTMSP”) have been observed since 1983. This material contained a large free volume (˜30%), and was able to separate organic compounds from gases or water. The stability of PTMSP is limited by its rapid loss of microporosity from reaction by heat, oxygen, radiation, UV light, non-uniform pore structure, or any combination of the above.

One recent display of porous organic materials is the polymers of intrinsic microporosity (PIMs). These polymers have been reported to contain relatively high surface areas (430-850 m²/g) measured by gas adsorption due to their highly rigid and contorted molecular structures unable to efficiently pack in space. These materials, however, display marked hysteresis at low pressures.

### SUMMARY

The disclosure provides a covalent-organic framework (COF) comprising two or more organic multidentate cores covalently bonded to a linking cluster, the linking cluster comprising an identifiable association of 2 or more atoms, wherein the covalent bonds between each multidentate core and the linking cluster take place between atoms selected from carbon, boron, oxygen, nitrogen and phosphorus and at least one of the atoms connecting multidentate cores is an oxygen. In one embodiment, the organic multidentate core can covalently bond to 2 or more (e.g., 3 or 4) multidentate linking clusters.

The disclosure also provides a covalent organic framework (COF) comprising two or more frameworks covalently bonded to one another. In one embodiment, the framework comprises two or more nets linked together. The frameworks or nets can be the same or different. In another embodiment, the plurality of multidentate cores are heterogeneous. In yet another embodiment, the plurality of linking clusters are heterogeneous. In one embodiment, the plurality of multidentate cores comprise alternating tetrahedral and triangular multidentate cores.

The disclosure provides a covalent-organic framework (COF) comprising a plurality of multidentate cores, each multidentate core linked to at least one other multidentate core; a plurality of linking clusters that connects adjacent multidentate cores, and a plurality of pores, wherein the plurality of linked multidentate cores defines the pore. In one aspect, the plurality of multidentate cores are heterogeneous. In a more specific aspect, the multidentate cores comprise 2-4 linking clusters. In yet another aspect, the plurality of linking clusters are heterogeneous. In a specific aspect, the linking cluster is a boron-containing linking cluster. The plurality of multidentate cores can comprise alternating tetrahedral and triangular multidentate cores. In yet another aspect, each of the plurality of pores comprises a sufficient number of accessible sites for atomic or molecular adsorption. In a further aspect a surface area of a pore of the plurality of pores is greater than about 2000 m²/g (e.g., 3000-18,000). In a further aspect, a pore of the plurality of pores comprises a pore volume 0.1 to 0.99 cm³/cm³ (e.g., from about 0.4-0.5 cm³/cm³). The COF can have a framework density of about 0.17 g/cm³.

The disclosure also provides a covalent organic framework comprising a plurality of different multidentate cores; a plurality of linking cluster; wherein the linking cluster links at least two of the plurality of multidentate cores and wherein the COF comprises a pore volume about 0.4 to about 0.9 cm³/cm³, a pore surface area of about 2,900 m2/g to about 18,000 m2/g and a framework density of about 0.17 g/cm³.

The disclosure also provides a gas storage device comprising a COF of the disclosure.

The disclosure also provides a gas separation device comprising a COF of the disclosure.

The disclosure also provides a sensor comprising a COF of the disclosure and a conductive sensor material.

Also provided are devices for the sorptive uptake of a chemical species. The device includes a sorbent comprising a covalent-organic framework (COF) provided herein. The uptake can be reversible or non-reversible. In some aspects, the sorbent is included in discrete sorptive particles. The sorptive particles may be embedded into or fixed to a solid liquid- and/or gas-permeable three-dimensional support. In some aspects, the sorptive particles have pores for the reversible uptake or storage of liquids or gases and wherein the sorptive particles can reversibly adsorb or absorb the liquid or gas.

In some embodiments, a device provided herein comprises a storage unit for the storage of chemical species such as ammonia, carbon dioxide, carbon monoxide, hydrogen, amines, methane, oxygen, argon, nitrogen, argon, organic dyes, polycyclic organic molecules, and combinations thereof.

Also provided are methods for the sorptive uptake of a chemical species. The method includes contacting the chemical species with a sorbent that includes a covalent-organic framework (COF) provided herein. The uptake of the chemical species may include storage of the chemical species. In some aspects, the chemical species is stored under conditions suitable for use as an energy source.

Also provided are methods for the sorptive uptake of a chemical species which includes contacting the chemical species with a device provided herein.

### DESCRIPTION OF DRAWINGS

FIG. 1. Representative condensation routes to 3-D COFs. Boronic acids (A) and (B) are tetrahedral building units and (C) a planar triangle unit (polyhedra in orange and triangles in blue, respectively), including fragments revealing the boroxine B₃O₃ (D) and the C₂O₂B (E) ring connectivity in the expected linked products. These building units can be placed on the ctn (F) and bor (G) nets as shown in the corresponding expanded nets (H) and (I), respectively.

FIG. 2. Calculated PXRD patterns for COF-102 (A), COF-103 (B), COF-105 (C), and COF-108 (D) using Cerius² and their corresponding measured patterns for evacuated samples (E-H), with the observed pattern in black, the refined profile in red, and the difference plot in blue (observed minus refined profiles). ¹¹B magic-angle spinning NMR spectra are given (inset) of (top) COF, (middle) model compound, and (bottom) boronic acid used to construct the corresponding COF.

FIG. 3. Atomic connectivity and structure of crystalline products of (A) COF-102 (B) COF-105, and (C) COF-108, based on powder X-ray diffraction and modeling (H atoms are omitted for clarity). Carbon, boron, and oxygen are represented as gray, orange, and red spheres, respectively.

FIG. 4 Argon gas adsorption isotherms for COF-102 (A) and COF-103 (B) measured at 87 K and pore size histograms (insets) calculated after fitting DFT models to gas adsorption data.

FIG. 5: PXRD pattern of COF-102 as synthesized before activation and removal of guests from the pores. Note that the large amorphous background arises from disordered guests in the pores.

FIG. 6: PXRD pattern of evacuated COF-102 (top) compared to patterns calculated from Cerius² for potential ctn and bor structures, ctn topology (middle), and bor topology (bottom). Note the pattern from the bor model does not match the pattern of COF-102. Note that the experimental pattern matches that for the ctn-model, and emergence of the flat baseline with removal of guests from the pores.

FIG. 7: PXRD pattern of COF-103 as synthesized before activation and removal of guests from the pores. Note the large amorphous background arises from disordered guests in the pores.

FIG. 8: PXRD pattern of evacuated COF-103 (top) compared to patterns calculated from Cerius² for potential ctn and bor structures, ctn topology (middle), and bor topology (bottom). Note the pattern from the bor model does not match the pattern of COF-103. Note that the experimental pattern matches that for the ctn-model, and the emergence of a flat baseline with removal of guests from the pores.

FIG. 9: PXRD pattern of COF-105 as synthesized before activation and removal of guest molecules. Note the large amorphous background arises from disordered guests in the pores.

FIG. 10: PXRD pattern of evacuated COF-105 (top) compared to patterns calculated from Cerius² for potential ctn and bor structures, ctn topology (middle), and bor topology (bottom). Note the pattern from the bor model does not match the pattern of COF-105. Note that the experimental pattern matches that for the ctn-model and the emergence of a flat baseline with removal of guests from the pores.

FIG. 11: PXRD pattern of COF-108 as synthesized before activation and removal of guest molecules.

FIG. 12: PXRD pattern of “as prepared” COF-108 (top) compared to patterns calculated from Cerius² for potential ctn and bor structures, ctn topology (bottom), and bor topology (middle). Note the pattern from the bor matches the experimental pattern of COF-108. Note that the experimental pattern does not match that for the ctn-model and the emergence of a flat baseline with removal of guests from the pores.

FIG. 13: FT-IR spectrum of tetra(4-(dihydroxy)borylphenyl)methane.

FIG. 14: FT-IR spectrum of tetra(4-(dihydroxy)borylphenyl)silane.

FIG. 15: FT-IR spectrum of triphenylboroxine (model compound).

FIG. 16: FT-IR spectrum of COF-5 (model compound).

FIG. 17: FT-IR spectrum of 2,3,6,7,10,11-hexahydroxytriphenylene (HHTP).

FIG. 18: FT-IR spectrum of COF-102. Note that the hydroxyl band stretch of the boronic acid is almost absent indicating a completed consumption of the starting materials. The formation of the B₃O₃ ring is supported by the following IR-bands (cm⁻¹): B—O (1378), B—O (1342), B—C (1226), B₃O₃ (710).

FIG. 19: FT-IR spectrum of COF-103. Note that the hydroxyl band stretch of the boronic acid is almost absent indicating a completed consumption of the starting materials. The formation of the B₃O₃ ring is supported by the following IR-bands (cm⁻¹): B—O (1387), B—O (1357), B—C (1226), B₃O₃ (710)

FIG. 20: FT-IR spectrum of COF-105. Note that the hydroxyl band stretch of the boronic acid is almost absent indicating a completed consumption of the starting materials. The formation of the C₂B₂O ring is supported by the following IR-bands (cm⁻¹): B—O (1398), B—O (1362), C—O (1245), B—C (1021).

FIG. 21: FT-IR spectrum of COF-108. Note that the hydroxyl band stretch of the boronic acid is almost absent indicating a completed consumption of the starting materials. The formation of the C₂B₂O ring is supported by the following IR-bands (cm⁻¹): B—O (1369), C—O (1253), and B—C (1026).

FIG. 22: Solid-state ¹¹B NMR spectrum for tetra(4-(dihydroxy)borylphenyl)methane. The presence of one signal indicates that only one type of boron species is present in the sample confirming the purity of the starting material.

FIG. 23: Solid-state ¹¹B NMR spectrum for triphenylboroxine (model compound). The presence of only one signal indicates that only one type of boron species is present. The peak is slightly shifted in position indicating a change in the environment around the boron, but the similar peak shapes and chemical shift of the boronic acid starting material and the triphenylboroxine indicates that the boron oxygen bonds are still present.

FIG. 24: Solid-state ¹¹B NMR spectrum for COF-102. The chemical shift position and peak shape of the single signal match the spectra obtained for the model compound, triphenylboroxine. The single signal indicates that only one type of boron species is present confirming the purity of the product.

FIG. 25: Stack plot comparing the ¹¹B NMR spectra of COF-102, triphenylboroxine, and tetra(4-(dihydroxy)borylphenyl)methane.

FIG. 26: Solid-state ¹³C NMR spectrum for tetra(4-(dihydroxy)borylphenyl)methane. All the expected signals are present and match the predicted chemical shift values. Spinning side bands are present as well.

FIG. 27: Solid-state ¹³C NMR spectrum for COF-102. All the signals from the starting boronic acid are present and no other signals are found except spinning side bands indicating the survival of the backbone and purity of the material.

FIG. 28: Solid-state ¹¹B NMR spectrum for tetra(4-(dihydroxy)borylphenyl)silane. The presence of one signal indicates that only one type of boron species is present in the sample confirming the purity of the starting material.

FIG. 29: Solid-state ¹¹B NMR spectrum for COF-103. The chemical shift position and peak shape of the single signal match the spectra obtained for the model compound, triphenylboroxine. The single signal indicates that only one type of boron species is present confirming the purity of the product.

FIG. 30: Stack plot comparing the ¹¹B NMR spectra of COF-103, triphenylboroxine, and tetra(4-(dihydroxy)borylphenyl)silane.

FIG. 31: Solid-state ¹³C NMR spectrum for tetra(4-(dihydroxy)borylphenyl)silane. All the expected signals are present and match the predicted chemical shift values. Spinning side bands are present as well. The separate carbon signals are too close in chemical shift to be resolved.

FIG. 32: Solid-state ¹³C NMR spectrum for COF-103. All the signals from the starting boronic acid are present and no other signals are found except spinning side bands indicating the survival of the backbone and purity of the material. The peak at 20 ppm comes from mesitylene inside the structure.

FIG. 33: Solid-state ²⁹Si spectra for COF-103 (top) and tetra(4-(dihydroxy)borylphenyl)silane (bottom). Note that spectrum of COF-103 contains only one resonance for the silicon nuclei exhibiting a chemical shift very similar to that of the tetra(4-(dihydroxy)borylphenyl)silane indicating the integrity of the tetrahedral block and the exclusion of any Si-containing impurities.

FIG. 34: Solid-state ²⁹Si NMR spectrum for COF-103. The single signal at −12.65 ppm indicates that the silicon carbon bond has survived the reaction.

FIG. 35: Solid-state ¹¹B NMR spectrum of COF-5 (model compound). The single signal present shows only one type of boron species is present. The peak shape is much different than that obtained for the starting material. This is the expected result because the model compound should contain BO₂C₂ boronate esters which create a different environment around the boron.

FIG. 36: Solid-state ¹¹B NMR spectrum of COF-105. The single peak shows that the product is pure and contains only one type of boron atom. The distinctive peak shape is very different from the starting material and matches the peak shape obtained for the model compound (COF-5).

FIG. 37: Stack plot comparing the ¹¹B NMR spectra of COF-105, COF-5 (model compound), and tetra(4-(dihydroxy)borylphenyl)silane.

FIG. 38: Solid-state ²⁹Si NMR spectrum for COF-105 showing the expected ²⁹Si signal for a tetraphenyl bonded Si nucleus at a chemical shift of −13.53 ppm. Note that spectrum of COF-105 contains only one resonance for the silicon nuclei exhibiting a chemical shift very similar to that of the tetra(4-(dihydroxy)borylphenyl)silane indicating the integrity of the tetrahedral block and the exclusion of any Si-containing impurities.

FIG. 39: Solid-state ¹³C NMR spectrum for COF-105. Note the resonances at 104.54 and 148.50 ppm indicate the incorporation of tetraphenylene molecule. All the expected peaks from the starting material are present showing the survival of the building block. Peaks arising from incorporation of the HHTP are also present confirming the identity of the product. Some of the carbon signals are too close in chemical shift to be resolved.

FIG. 40: Solid-state ¹¹B NMR spectrum of COF-108. The single peak shows that the product is pure and contains only one type of boron atom. The distinctive peak shape is very different from the starting material and matches the peak shape obtained for the model compound (COF-5).

FIG. 41: Stack plot comparing the solid-state ¹¹B NMR spectra of COF-108, COF-5, and tetra(4-(dihydroxy)borylphenyl)methane.

FIG. 42: Solid-state ¹³C NMR spectrum for COF-108. Note the resonances at 104.66 and 148.96 ppm indicate the incorporation of tetraphenylene molecule. All the expected peaks from the starting material are present showing the survival of the building block. Peaks arising from incorporation of the HHTP are also present confirming the existence of the product.

FIG. 43: SEM image of COF-102 revealing a spherical morphology.

FIG. 44: SEM image of COF-103 revealing a spherical morphology.

FIG. 45: SEM image of COF-105 revealing pallet morphology.

FIG. 46: SEM image of COF-108 revealing a deformed spherical morphology.

FIG. 47: TGA trace for an activated sample of COF-102.

FIG. 48: TGA trace for an activated sample of COF-103.

FIG. 49: TGA trace for an activated sample of COF-105.

FIG. 50: TGA trace for an activated sample of COF-108.

FIG. 51: Argon adsorption isotherm for COF-102 measured at 87° K. and the Pore Size Distribution (PSD) obtained from the NLDFT method. The filled circles are adsorption points and the empty circles are desorption points.

FIG. 52: Experimental Ar adsorption isotherm for COF-102 measured at 87° K. is shown as filled circles. The calculated NLDFT isotherm is overlaid as open circles. Note that a fitting error of <1% indicates the validity of using this method for assessing the porosity of COF-102. The fitting error is indicated.

FIG. 53: Langmuir plot for COF-102 calculated from the Ar adsorption isotherm at 87° K. The model was applied from P/Pₒ=0.04-0.85. The correlation factor is indicated. (W=Weight of gas absorbed at a relative pressure P/Pₒ).

FIG. 54: BET plot for COF-102 calculated from the Ar adsorption isotherm at 87° K. The model was applied from P/Pₒ=0.01-0.10. The correlation factor is indicated. (W=Weight of gas absorbed at a relative pressure P/Pₒ).

FIG. 55: Argon adsorption isotherm for COF-103 measured at 87° K. and the Pore Size Distribution (PSD) obtained from the NLDFT method. The filled circles are adsorption points and the empty circles are desorption points.

FIG. 56: Experimental Ar adsorption isotherm for COF-103 measured at 87° K. is showed as filled circles. The calculated NLDFT isotherm is overlaid as open circles. Note that a fitting error of <1% indicates the validity of using this method for assessing the porosity of COF-103. The fitting error is indicated.

FIG. 57: Langmuir plot for COF-103 calculated from the Ar adsorption isotherm at 87° K. The model was applied from P/Pₒ=0.04-0.85. The correlation factor is indicated. (W=Weight of gas absorbed at a relative pressure P/Pₒ).

FIG. 58: BET plot for COF-102 calculated from the Ar adsorption isotherm at 87° K. The model was applied from P/Pₒ=0.01-0.10. The correlation factor is indicated. (W=Weight of gas absorbed at a relative pressure P/Pₒ).

FIG. 59: Dubinin-Radushkevich plot used for pore volume estimation for COF-102 using argon gas. The Dubinin-Astakhov (DA) was applied and the same results were found (n=2).

FIG. 60: Dubinin-Radushkevich plot used for pore volume estimation for COF-103 using argon gas. The Dubinin-Astakhov (DA) was applied and the same results were found (n=2).

FIG. 61: Low pressure Ar isotherms for COFs.

FIG. 62: Ar uptake data for COFs.

FIG. 63: High pressure CH₄ isotherms for COFs.

FIG. 64: CO₂ uptake data for COFs.

FIG. 65: Low pressure CO₂ isotherms for COFs

FIG. 66: High pressure CO₂ isotherms for COFs.

FIG. 67: CO₂ uptake data for all COFs.

FIG. 68: Low pressure H₂ isotherms for COFs.

FIG. 69: High pressure H₂ isotherms for COFs.

FIG. 70: H2 uptake data for all COFs.

FIG. 71: structural representations of COF-8, COF-10 and COF-12.

FIG. 72: is a graph showing low-pressure isotherm N2 sorption.

FIG. 72: shows N2 sorption data for various COFs.

### DETAILED DESCRIPTION

As used herein and in the appended claims, the singular forms “a,” “and,” and “the” include plural referents unless the context clearly dictates otherwise. Thus, for example, reference to “a pore” includes a plurality of such pores and reference to “the pore” includes reference to one or more pores, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

Any publications discussed above and throughout the text are provided solely for their disclosure prior to the filing date of the present application. Nothing herein is to be construed as an admission that the inventors are not entitled to antedate such disclosure by virtue of prior disclosure.

Covalently linked organic networks differ from existing cross-linked polymers and other polymeric materials whose properties are a result of various processing techniques in that organic crystalline networks have clearly defined molecular architectures that are intrinsic to the material. Accurate control over the position of selected organic units in an extended structure is needed to allow optimum exploitation of the material properties.

Existing crystalline covalently linked materials such as diamond, graphite, silicon carbide, carbon nitride, and boron nitride are formed under very high pressures (1-10 GPa) or very high temperatures (500-2400° C.). These extreme synthetic conditions limit the flexibility needed in the formation of extended or functionalized structures, since the structural or chemical integrity of many organic monomer units is not preserved under these conditions.

Current attempts towards synthesizing covalent networks under mild conditions have been unsuccessful in producing extended materials that have periodic molecular structures with long-range order. One such attempt involved the pre-organization of organic moieties via hydrogen bonding or metal-ligand interactions prior to the diffusion of a reactive non-metallic cross-linking agent into the channels. This linked the pre-arranged organic molecules together, and the metal template ions were subsequently removed. Incomplete polymerization or loss of crystallinity upon removal of the metal template ions, however, is often observed.

The chemistry of linking together organic molecules with covalent bonds to isolate crystals of discrete 0-dimensional (0-D) molecules and 1-D chains (polymers) is established; however, it is undeveloped for 2-D and 3-D covalent organic frameworks (COFs). The disclosure provides covalent organic frameworks (COFs) in which the building blocks are linked by strong covalent bonds (C—C, C—O, B—O). The crystallization of COFs indicates that it is possible to overcome the long standing “crystallization problem” for covalently linked solids. This is accomplished by striking a balance between the kinetic and thermodynamic factors that play in reversible covalent bond formation, a criterion to crystallize extended structures.

The realization of COF structures containing light elements (B, C, N, and O) provide highly desirable materials because they combine the thermodynamic strength of covalent bonds, as in diamond and boron carbides, with the functionality of organic units. Progress in this area has been impeded by long standing practical and conceptual challenges. Firstly, unlike 0-D and 1-D systems, the insolubility of 2-D and 3-D structures precludes the use of step-wise synthesis, making their isolation in crystalline form very difficult. Secondly, the number of possible structures that may result from linking specific building unit geometries into 2-D or 3-D extended structures is essentially infinite and complicates their synthesis by design.

The formation of covalently linked organic networks has been an elusive goal and an attractive challenge in both molecular design and organic chemistry. These networks can be defined as periodic especially “2-D or 3-D” materials composed of strong, kinetically inert, covalent bonds (e.g. between C, O, N, B). In addition to its stimulating synthetic challenge, properties of these new materials may have important industrial applications taking advantage of their lightweight, inexpensive starting materials, and potentially high chemical and thermal stabilities. By employing specific organic units in a periodic array at the molecular scale, one can specifically tailor structure, functionality, and material properties. This is achieved by operating under mild conditions that do not destroy the structural or physical properties of the building blocks translation into extended networks.

Covalent organic frameworks of the disclosure are based, in part, upon choosing building blocks and using reversible condensation reactions to crystallize 2-D and 3-D COFs in which organic building blocks are linked by strong covalent bonds. In addition, the disclosure demonstrates that the design principles of reticular chemistry overcome difficulties with prior efforts. For example, using reticular chemistry, nets were developed by linking different multidentate cores. The different multidentate cores can each be linked to a different number of additional multidentate cores (e.g., 2, 3, 4 or more) through a linking cluster. Each net can then be further linked to any number of additional nets.

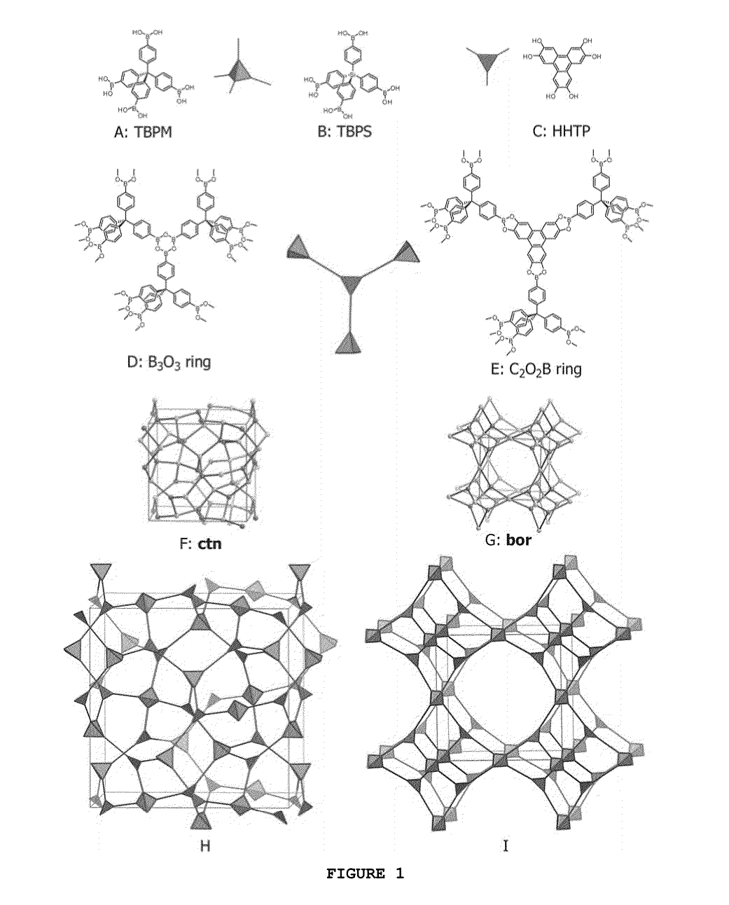

For example, two nets based on linking of triangular and tetrahedral shapes were selected and targeted for the synthesis of 3-D COFs. For example, self-condensation and co-condensation reactions of the rigid molecular building blocks, the tetrahedral tetra(4-dihydroxyborylphenyl)methane (TBPM), and its silane analogue (TBPS), and triangular hexahydroxytriphenylene (HHTP) (FIG. 1A-C) provide an example of crystalline 3-D COFs (termed COF-102, -103, -105, and -108).

Accordingly, the disclosure provides two- and three-dimensional covalent organic frameworks (3-D COFs) synthesized from molecular building blocks using concepts of reticular chemistry. For example, two nets based on triangular and tetrahedral cores, ctn and bor, were targeted and their respective 3-D COFs synthesized as crystalline solids by condensation reactions of tetrahedral, tetra(4-dihydroxyborylphenyl)methane (TBPM, C[C₆H₄B(OH)₂]₄) or tetra(4-dihydroxyborylphenyl)silane (TBPS, Si[C₆H₄B(OH)₂]₄), and co-condensation of triangular, 2,3,6,7,10,11-hexahydroxytriphenylene (HHTP). The resulting 3-D COFs are expanded versions of ctn and bor nets: COF-102 (ctn), COF-103 (ctn), COF-105 (ctn) and COF-108 (bor). They are entirely constructed from strong covalent bonds (C—C, C—O, C—B, and B—O) and have high thermal stability (400-500° C.); the highest surface areas known for any organic material (3472 m² g⁻¹ and 4210 m² g⁻¹) and the lowest density (0.17 gcm⁻³) of any crystalline solid.

The COFs of the disclosure are the most porous among organic materials and members of this series (e.g., COF-108) have some of the lowest density of any crystalline material. Without an a priori knowledge of the expected underlying nets of these COFs, their synthesis by design and solving their structures from powder X-ray diffraction data would have been prohibitively difficult.

A covalent organic framework (“COF”) refers to a two- or three-dimensional network of covalently bonded multidentate cores bonded wherein the multidentate cores are bonded to one another through linking clusters. In one aspect a COF comprises two or more networks covalently bonded to one another. The networks may be the same or different. These structures are extended in the same sense that polymers are extended.

The term “covalent organic network” refers collectively to both covalent organic frameworks and to covalent organic polyhedra.

The term “covalent organic polyhedra” refers to a non-extended covalent organic network. Polymerization in such polyhedra does not occur usually because of the presence of capping ligands that inhibit polymerization. Covalent organic polyhedra are covalent organic networks that comprise a plurality of linking clusters linking together multidentate cores such that the spatial structure of the network is a polyhedron. Typically, the polyhedra of this variation are 2 or 3 dimensional structures.

The term “cluster” refers to identifiable associations of 2 or more atoms. Such associations are typically established by some type of bond-ionic, covalent, Van der Waal, and the like. A “linking cluster” refers to a one or more reactive species capable of condensation comprising an atom capable of forming a bond through a bridging oxygen atom with a multidentate core. Examples of such species are selected from the group consisting of a boron, oxygen, carbon, nitrogen, and phosphorous atom. In some embodiments, the linking cluster may comprise one or more different reactive species capable of forming a link with a bridging oxygen atom.

As used herein, a line in a chemical formula with an atom on one end and nothing on the other end means that the formula refers to a chemical fragment that is bonded to another entity on the end without an atom attached. Sometimes for emphasis, a wavy line will intersect the line.

The disclosure provides covalently linked organic networks of any number of net structures (e.g., frameworks). The covalently linked organic network comprises a plurality of multidentate cores wherein at least two multidentate cores comprise a different number of linking sites capable of condensation with a linking cluster. The multidentate cores are linked to one another by at least one linking cluster. Variations of the covalently linked organic networks (both the frameworks and polyhedra) can provide surface areas from about 1 to about 20,000 m²/g or more, typically about 2000 to about 18,000 m²/g, but more commonly about 3,000 to about 6,000 m²/g.

Typically each multidentate core is linked to at least one, typically two, distinct multidentate cores. In a variation of this embodiment, the covalently linked organic networks are covalently linked organic frameworks (“COFs”) which are extended structures. In a further refinement these COFs are crystalline materials that may be either polycrystalline or even single crystals. The multidentate cores may be the same throughout the net (i.e., a homogenous net) or may be different or alternating types of multidentate cores (i.e., a heterogeneous net). Since the covalently bonded organic frameworks are extended structures, variation may form into analogous nets to the nets found in metallic organic frameworks as described in Reticular Chemistry: Occurrence and Taxonomy of Nets and Grammar for the Design of Frameworks, Acc. Chem. Res. 2005, 38, 176-182. The entire disclosure of this article is hereby incorporated by reference.

The linking cluster can have two or more linkages (e.g., three or more linkages) to obtain 2D and 3D-frameworks including cages and ring structures. In one aspect, one linking cluster capable of linking a plurality of multidentate cores comprises a clusters having a structure described by the formula AₓQ_{y}T_{w}C_{z}, wherein A and T are bridged by Q making x and w equal; A is a boron, carbon, oxygen, sulfur nitrogen or phosphorous; T is any non-metal element; Q is oxygen, sulfur, nitrogen, or phosphorus, which has a number y in accordance with filling the valency of A. In one aspect, T is selected from the group consisting of B, O, N, Si, and P. In yet another aspect, the linking cluster has a structure described by the formula AₓQ_{y}Cz wherein A is boron, carbon, oxygen, sulfur nitrogen or phosphorous, Q is oxygen, sulfur, nitrogen, or phosphorus; x and y are integers such that the valency of A is satisfied, and z is an integer from 0 to 6. In on useful variation, the linking cluster has the formula BₓQ_{y}Cz wherein Q is oxygen, sulfur, nitrogen, or phosphorus; x and y are integers such that the valency of B is satisfied, and z is an integer from 0 to 6. In yet another aspect, the linking cluster has the formula BₓO_{y}. In one aspect, a multidentate core is linked of at least one other multidentate core by at least 2, at least 3 or at least 4 boron containing clusters. In one aspect, the boron-containing cluster comprises at least 2 or at least 4 oxygens capable of forming a link. For example, a boron-containing cluster of a multidentate core comprises Formula I:

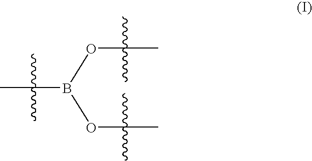

Multidentate cores of the disclosure can comprise substituted or unsubstituted aromatic rings, substituted or unsubstituted heteroaromatic rings, substituted or unsubstituted nonaromatic rings, substituted or unsubstituted nonaromatic heterocyclic rings, or saturated or unsaturated, substituted or unsubstituted, hydrocarbon groups. The saturated or unsaturated hydrocarbon groups may include one or more heteroatoms. For example, the multidentate core can comprise Formula II:

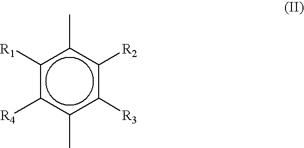

wherein R₁, R₂, R₃, and R₄ are each independently H, alkyl, aryl, OH, alkoxy, alkenes, alkynes, phenyl and substitutions of the foregoing, sulfur-containing groups (e.g., thioalkoxy), silicon-containing groups, nitrogen-containing groups (e.g., amides), oxygen-containing groups (e.g., ketones, and aldehydes), halogen, nitro, amino, cyano, boron-containing groups, phosphorus-containing groups, carboxylic acids, or esters.

In another variation of the multidentate core is described by Formula III:

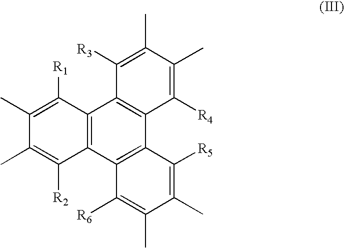

wherein R₁, R₂, R₃, R₄, R₅, and R₆ are each independently H, alkyl, aryl, OH, alkoxy, alkenes, alkynes, phenyl and substitutions of the foregoing, sulfur-containing groups (e.g., thioalkoxy), silicon-containing groups, nitrogen-containing groups (e.g., amides), oxygen-containing groups (e.g., ketones, and aldehydes), halogen, nitro, amino, cyano, boron-containing groups, phosphorus-containing groups, carboxylic acids, or esters.

In another variation the multidentate core is described by Formulae IV-VII:

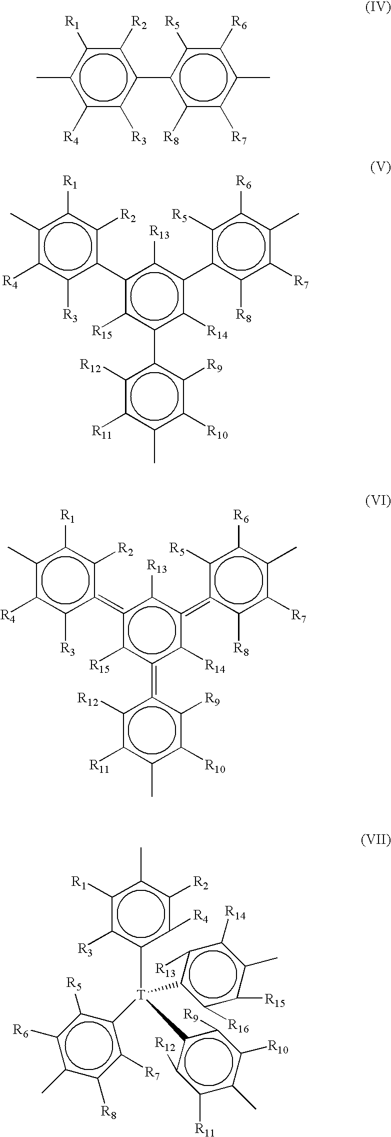

wherein R₁, R₂, R₃, R₄, R₅, R₆, R₇, R₈, R₉, R₁₀, R₁₁, R₁₂, R₁₃, R₁₄, R₁₅, and R₁₆ are each independently H, alkyl, aryl, OH, alkoxy, alkenes, alkynes, phenyl and substitutions of the foregoing, sulfur-containing groups (e.g., thioalkoxy), silicon-containing groups, nitrogen-containing groups (e.g., amides), oxygen-containing groups (e.g., ketones, and aldehydes), halogen, nitro, amino, cyano, boron-containing groups, phosphorus-containing groups, carboxylic acids, or esters and T is a tetrahedral atom (e.g., carbon, silicon, germanium, tin) or a tetrahedral group or cluster.

In another variation the multidentate core is described by Formula VII:

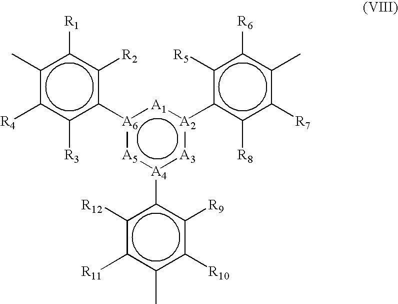

wherein A₁, A₂, A₃, A₄, A₅, and A₆ are each independently absent or any atom or group capable of forming a sable ring structure and R₁, R₂, R₃, R₄, R₅, R₆, R₇, R₈, R₉, R₁₀, R₁₁, and R₁₂ are each independently H, alkyl, aryl, OH, alkoxy, alkenes, alkynes, phenyl and substitutions of the foregoing, sulfur-containing groups (e.g., thioalkoxy), silicon-containing groups, nitrogen-containing groups (e.g., amides), oxygen-containing groups (e.g., ketones, and aldehydes), halogen, nitro, amino, cyano, boron-containing groups, phosphorus-containing groups, carboxylic acids, or esters. Specific examples of Formula VIII are provided by Formulae IX and X and ammonium salts of the linking groups of Formulae IX and X:

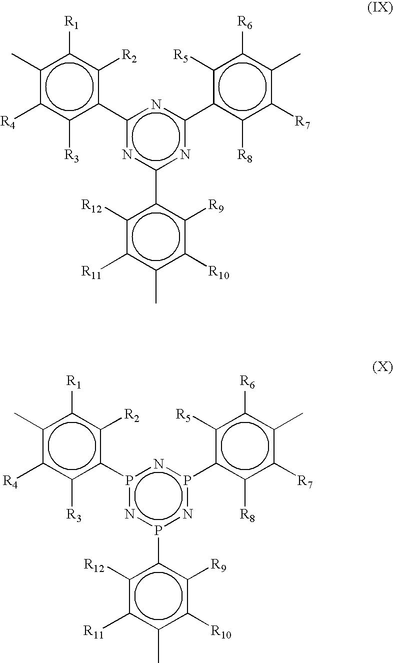

wherein R₁, R₂, R₃, R₄, R₅, R₆, R₇, R₈, R₉, R₁₀, R₁₁, and R₁₂ are each independently H, alkyl, aryl, OH, alkoxy, alkenes, alkynes, phenyl and substitutions of the foregoing, sulfur-containing groups (e.g., thioalkoxy), silicon-containing groups, nitrogen-containing groups (e.g., amides), oxygen-containing groups (e.g., ketones, and aldehydes), halogen, nitro, amino, cyano, boron-containing groups, phosphorus-containing groups, carboxylic acids, or esters.

In yet another variation the multidentate core is described by Formula XI:

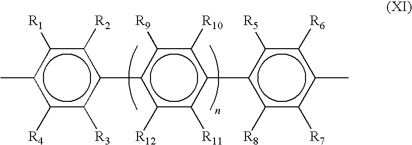

wherein R₁ through R₁₂ are each independently H, alkyl, aryl, OH, alkoxy, alkenes, alkynes, phenyl and substitutions of the foregoing, sulfur-containing groups (e.g., thioalkoxy), silicon-containing groups, nitrogen-containing groups (e.g., amides), oxygen-containing groups (e.g., ketones, and aldehydes), halogen, nitro, amino, cyano, boron-containing groups, phosphorus-containing groups, carboxylic acids, or esters; and n is an integer greater than or equal to 1.

In still another embodiment, a first multidentate core is linked to at least one second multidentate core by a boron-containing cluster (see, e.g., FIG. 1D). In still another aspect, a first multidentate core is linked to a second different multidentate core lacking by a boron-containing cluster (see, e.g., FIG. 1E).

The disclosure provides a covalent organic framework comprising two or more organic multidentate cores covalently bonded to a linking cluster, the linking cluster comprising an identifiable association of 2 or more atoms, wherein the covalent bonds between each multidentate core and the linking cluster take place between atoms selected from carbon, boron, oxygen, nitrogen and phosphorus and at least one of the atoms in each covalent bond between a multidentate core and the linking cluster is oxygen. One or more COFs can be covalently bonded to one another each COF can be identical or different in structure.

The covalently linked organic frameworks or polyhedra of the disclosure optionally further comprise a guest species. Such a guest species may increase the surface area of the covalently linked organic networks. In a similar manner, the covalently linked organic networks of the disclosure further comprises an adsorbed chemical species. Such adsorbed chemical species include for example, ammonia, carbon dioxide, carbon monoxide, hydrogen, amines, methane, oxygen, argon, nitrogen, organic dyes, polycyclic organic molecules, metal ions, inorganic clusters, organometallic clusters, and combinations thereof.

A method for forming a covalently linked organic frameworks and polyhedra set forth above is provided. In one variation of this embodiment, the method utilizes a multidentate core comprising at least one boron-containing cluster for use in condensation into an extended crystalline materials. Such multidentate core comprising a boron-containing cluster self-condenses the cores. In another aspect, a first multidentate core comprising a boron-containing cluster is condensed with a multidentate core lacking a boron-containing cluster. The crystalline product may be either polycrystalline or single crystal. For example, the condensation forms a porous, semicrystalline to crystalline organic materials with high surface areas.

In one aspect, phenylene bisboronic acids are condensed to form microporous crystalline compounds with high surface area. It has been reported in the structure of triphenylboroxine that the central B₃O₃ rings are found to be nearly planar, and the phenyl groups are nearly coplanar with boroxine ring.

Schemes I and II show methods for synthesizing 3D and 2D COFs of the disclosure. In accordance with Scheme 2, the dehydration reaction between phenylboronic acid and 2,3,6,7,10,11-hexahydroxytriphenylene (“HHTP”), a trigonal building block, gives a new 5-membered BO₂C₂ ring.

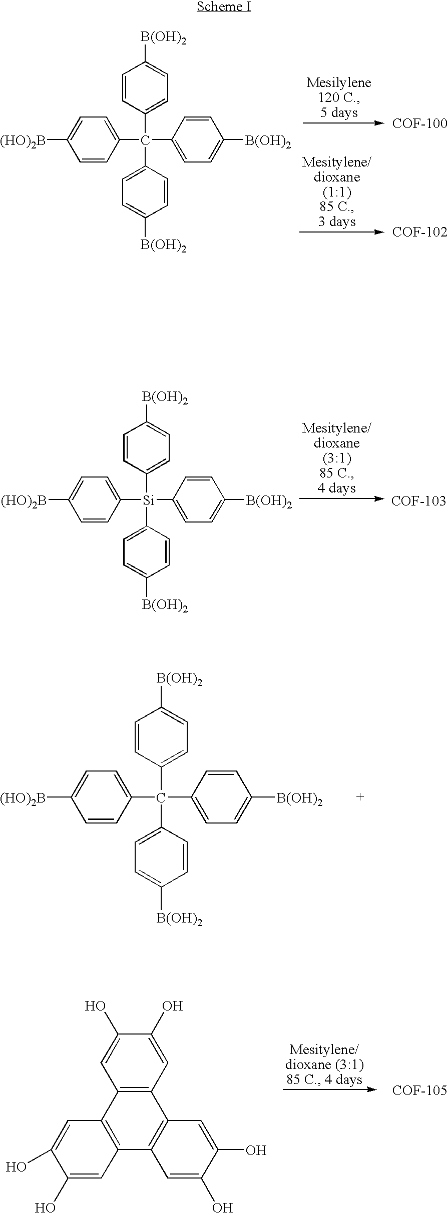

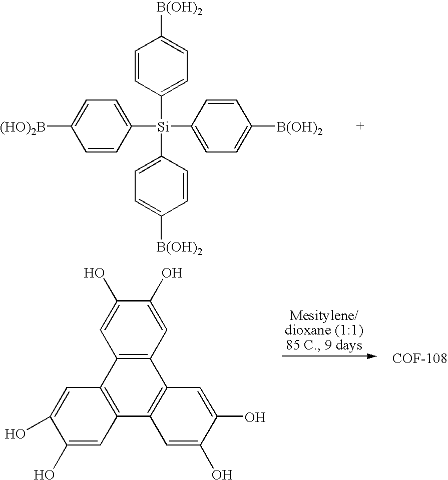

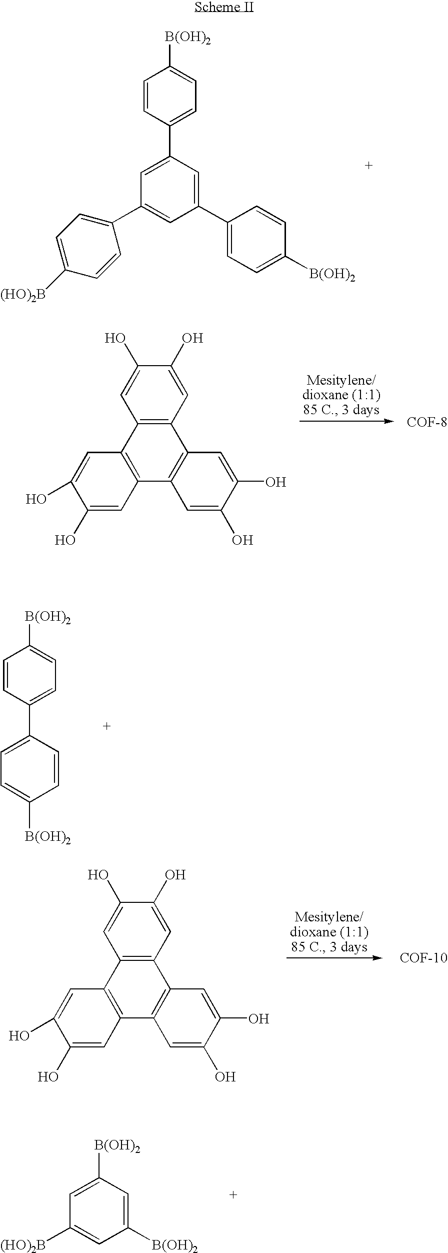

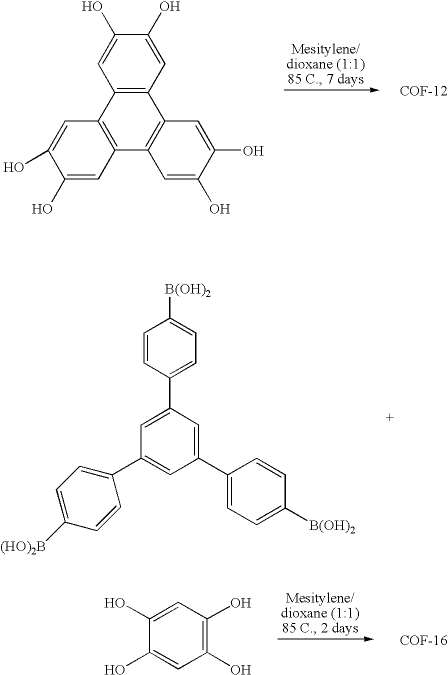

Reactions in aromatic solvents (e.g. toluene), like those used for discrete compounds, represents a logical starting point for COF synthesis. Scheme 2 provides an example of the reaction of BDBA with TBST to form a 3-connected sheet. In an analogous manner as set forth above, the aromatic rings of both the starting materials and products of Scheme 2 are optionally substituted with alkyl, OH, alkoxy, sulfur-containing groups (e.g., thioalkoxy), silicon-containing groups, halogen, nitro, amino, cyano, boron-containing groups, phosphorus-containing groups, carboxylic acids, or esters.

The COFs of the disclosure can take any framework/structure. For example, using the methods of the disclosure COFs having any of the following framework type codes can be obtained: ABW ACO AEI AEL AEN AET AFG AFI AFN AFO AFR AFS AFT AFX AFY AHT ANA APC APD AST ASV ATN ATO ATS ATT ATV AWO AWW BCT *BEA BEC BIK BOG BPH BRE CAN CAS CDO CFI CGF CGS CHA CHI CLO CON CZP DAC DDR DFO DFT DOH DON EAB EDI EMT EON EPI ERI ESV ETR EUO EZT FAR FAU FER FRA GIS GIU GME GON GOO HEU IFR IHW ISV ITE ITH ITW IWR IWV IWW JBW KFI LAU LEV LIO LIT LOS LOV LTA LTL LTN MAR MAZ MEI MEL MEP MER MFI MFS MON MOR MOZ MSE MSO MTF MTN MTT MTW MWW NAB NAT NES NON NPO NSI OBW OFF OSI OSO OWE PAR PAU PHI PON RHO RON RRO RSN RTE RTH RUT RWR RWY SAO SAS SAT SAV SBE SBS SBT SFE SFF SFG SFH SFN SFO SGT SIV SOD SOS SSY STF STI STT SZR TER THO TON TSC TUN UEI UFI UOZ USI UTL VET VFI VNI VSV WEI WEN YUG ZON.

In another aspect, the covalent-organic frameworks set forth above may include an interpenetrating covalent-organic framework that increases the surface area of the covalent-organic framework. Although the frameworks of the disclosure may advantageously exclude such interpenetration, there are circumstances when the inclusion of an interpenetrating framework may be used to increase the surface area.

A feature of 3-D COFs is the full accessibility from within the pores to all the edges and faces of the molecular units used to construct the framework. A previous study found that maximizing the number of edges arising from aromatic rings in a porous material increases the number of adsorption sites and surface area. Porous zeolites, carbons, and metal-organic frameworks (MOFs) all contain latent edges in their structures; however, the structure of COFs contain no latent edges and the entire framework is a surface replete with binding sites for gas adsorption. The structures also have extraordinarily low densities: COF-102, 0.41 gcm⁻³; COF-103, 0.38 gcm⁻³; COF-105, 0.18 gcm⁻³; and COF-108, 0.17 gcm⁻³. The last two are markedly lower than those of highly porous MOFs such as MOF-5 (0.59 gcm⁻³), and MOF-177 (0.42 gcm⁻³), and are the lowest density crystals known; compare also the density of diamond (3.50 g cm⁻³).

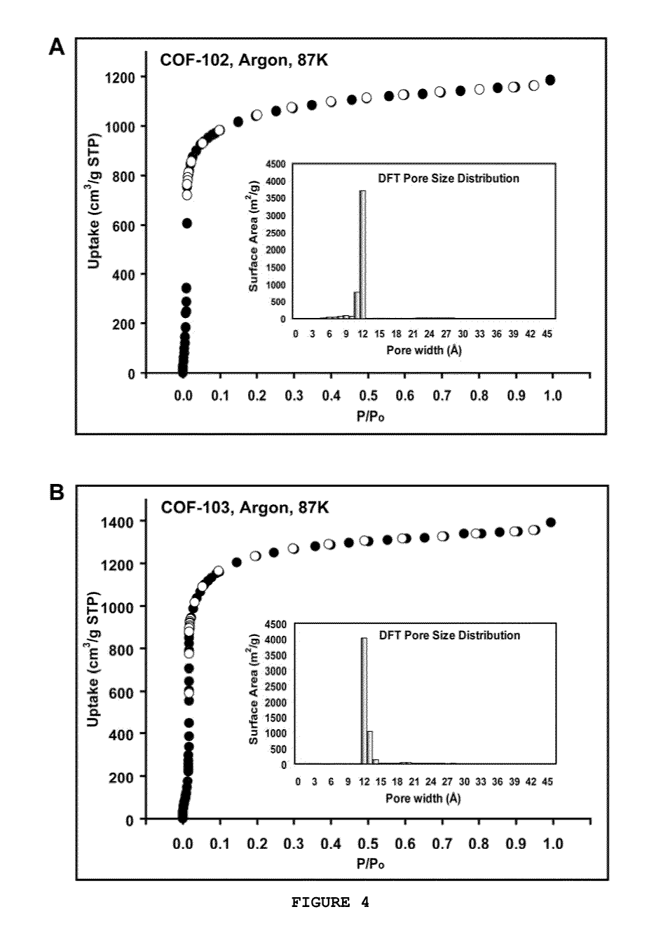

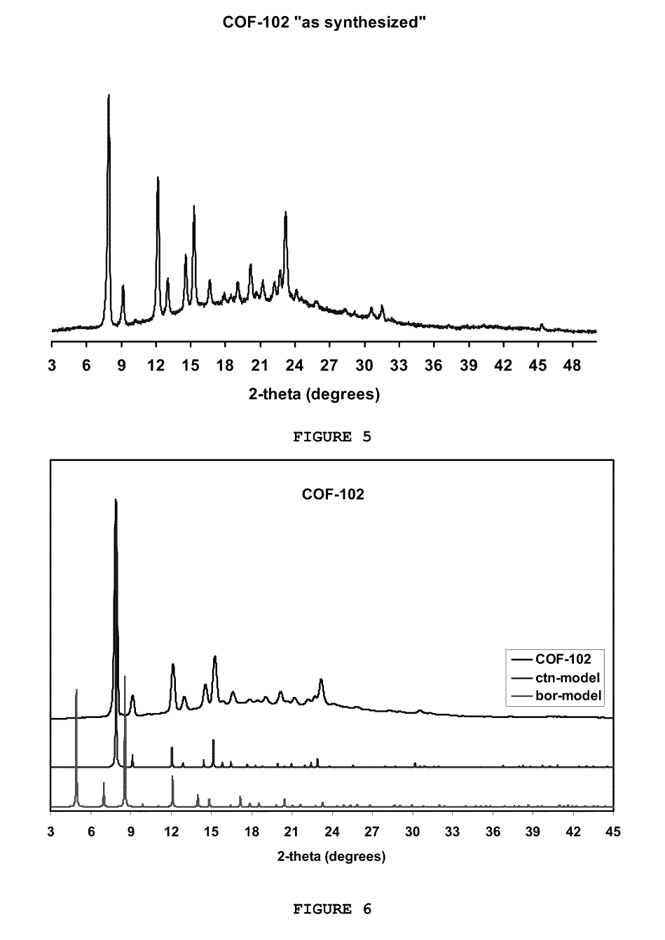

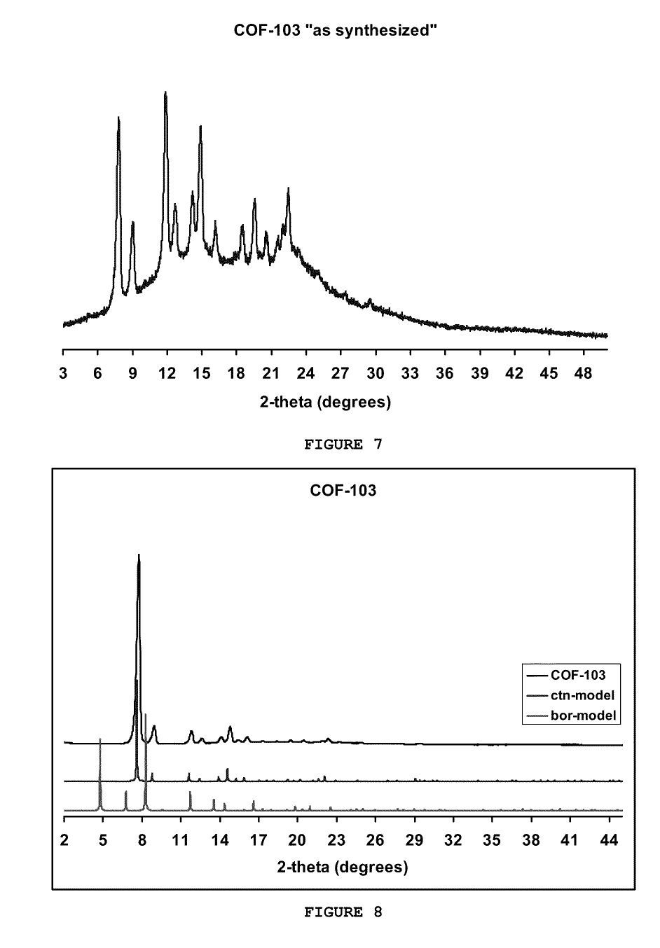

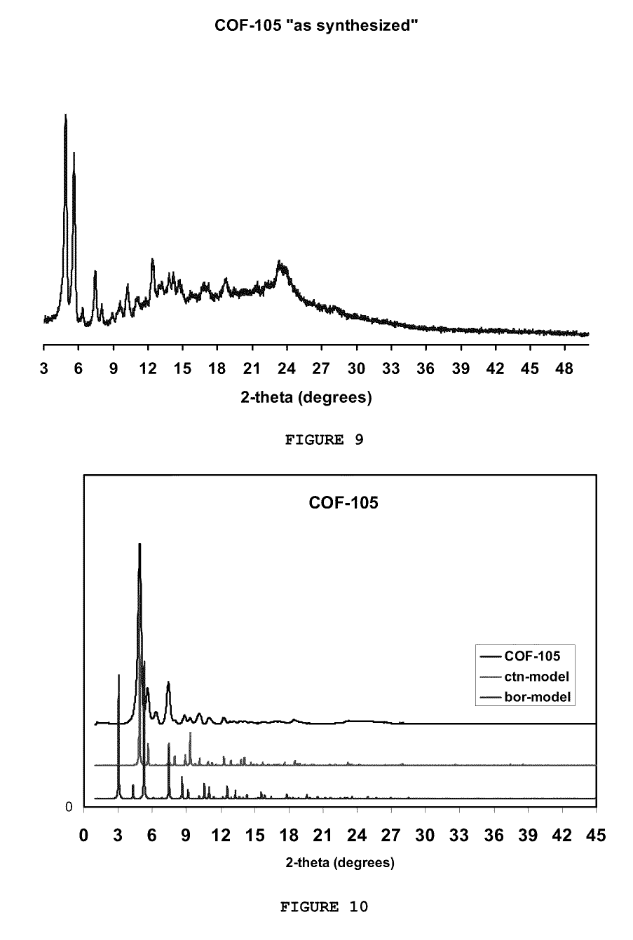

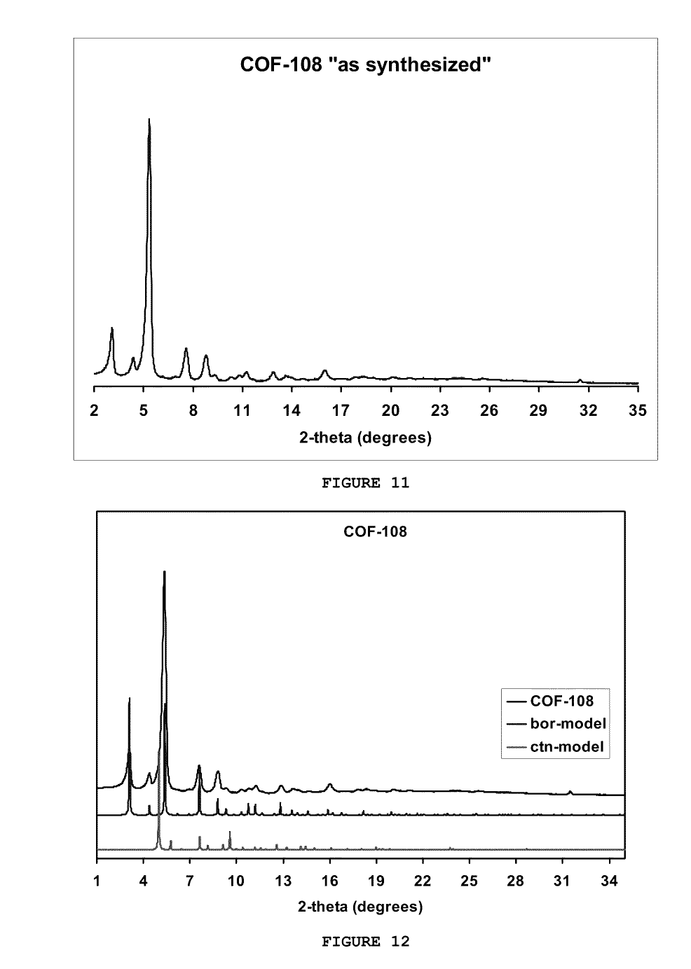

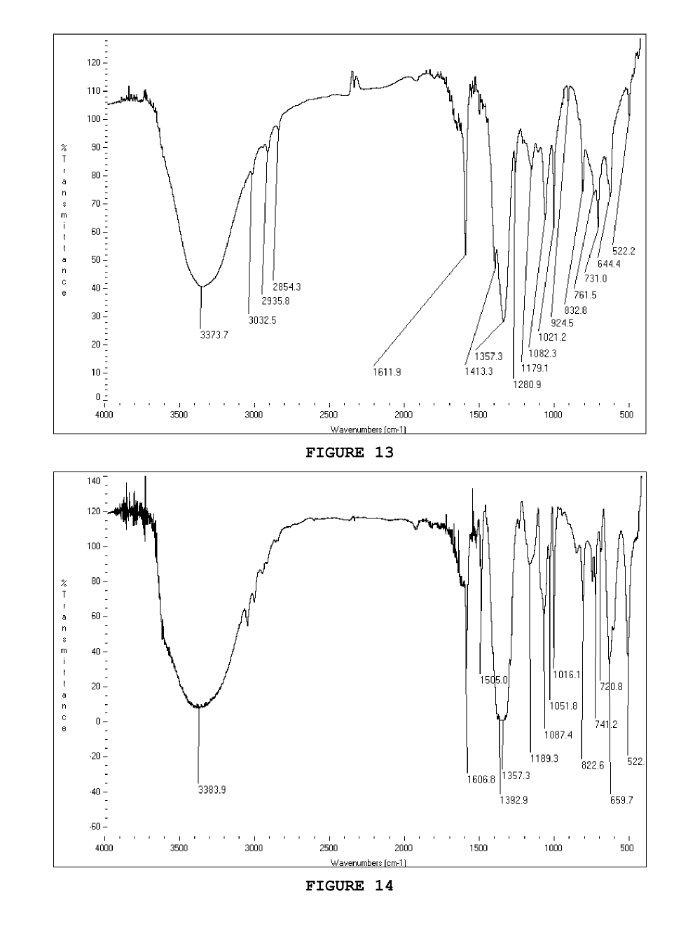

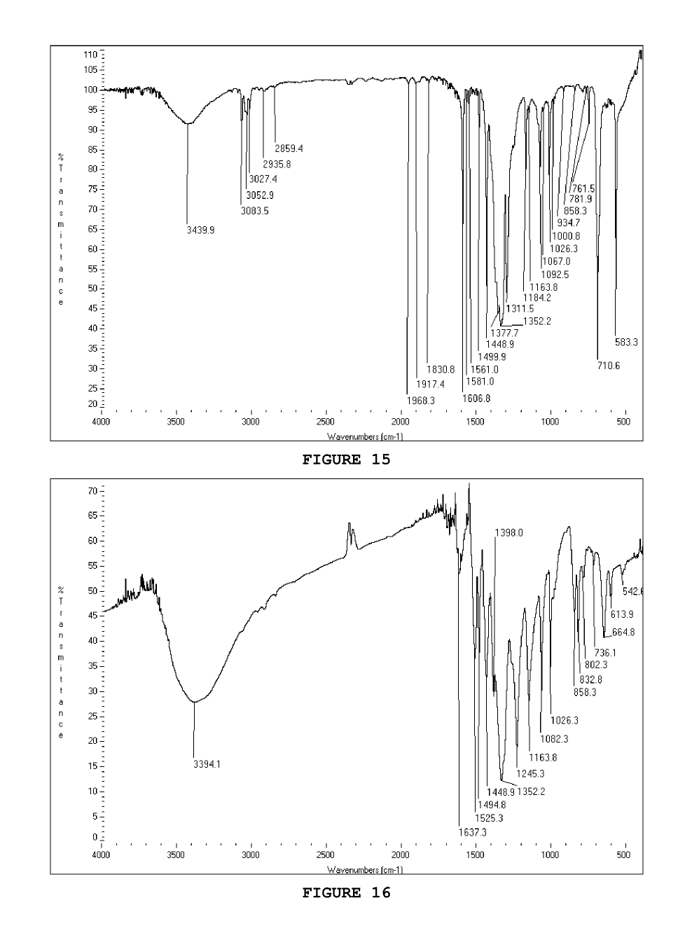

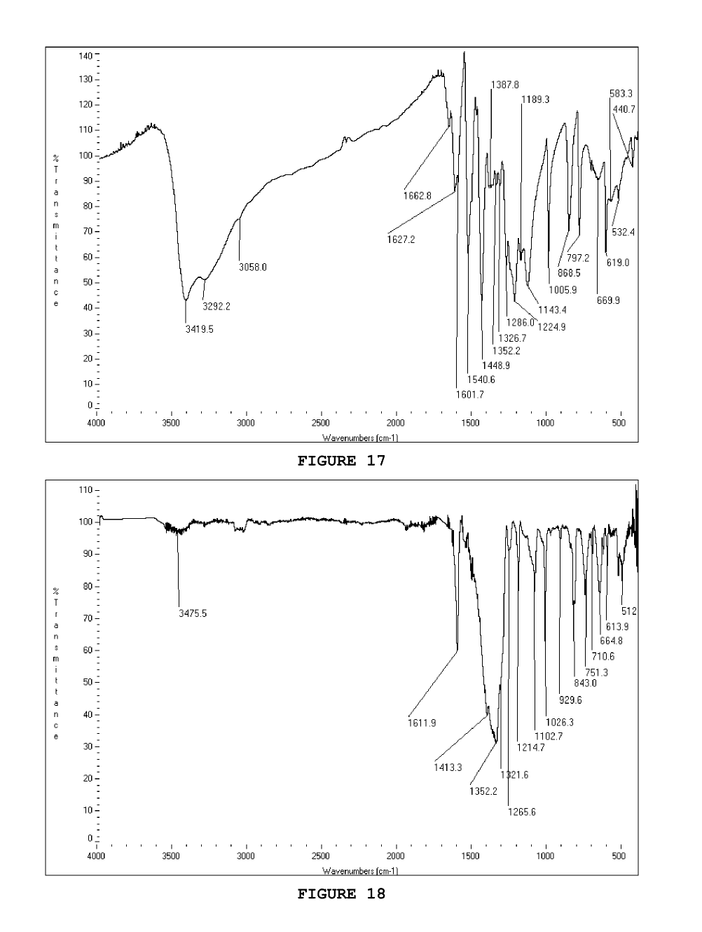

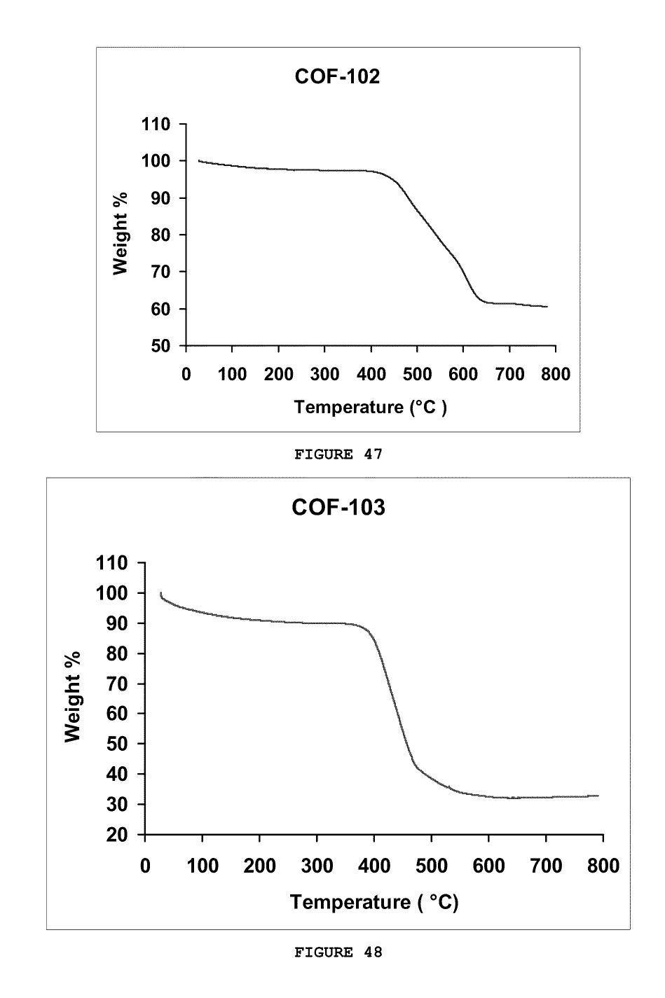

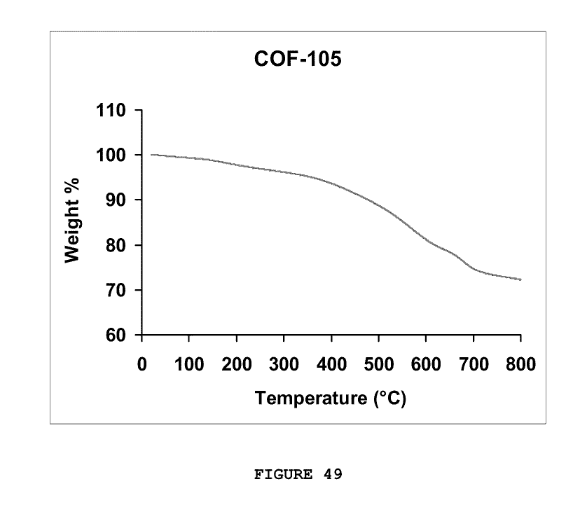

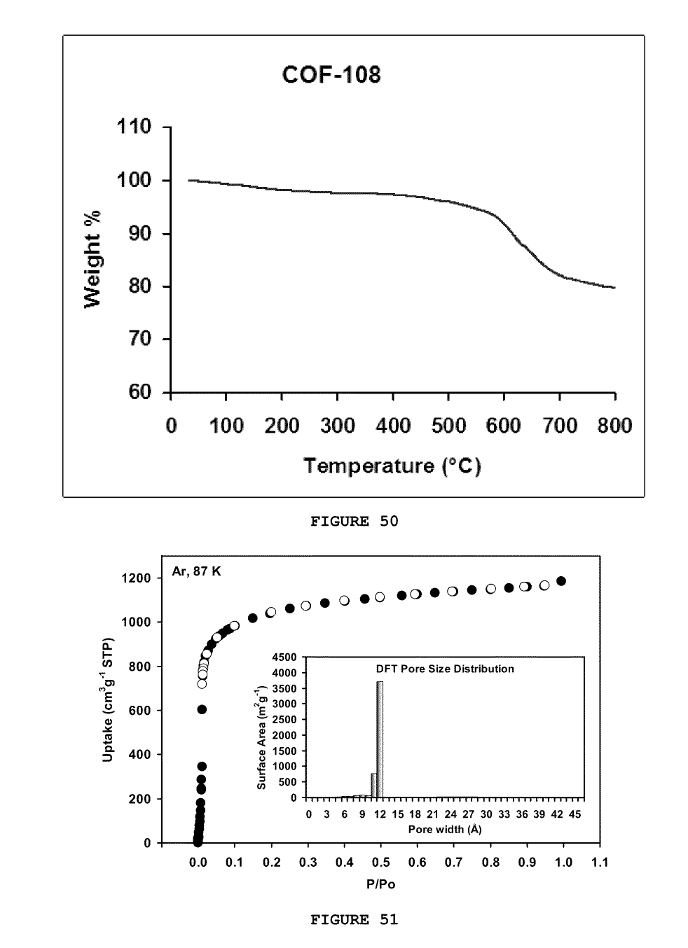

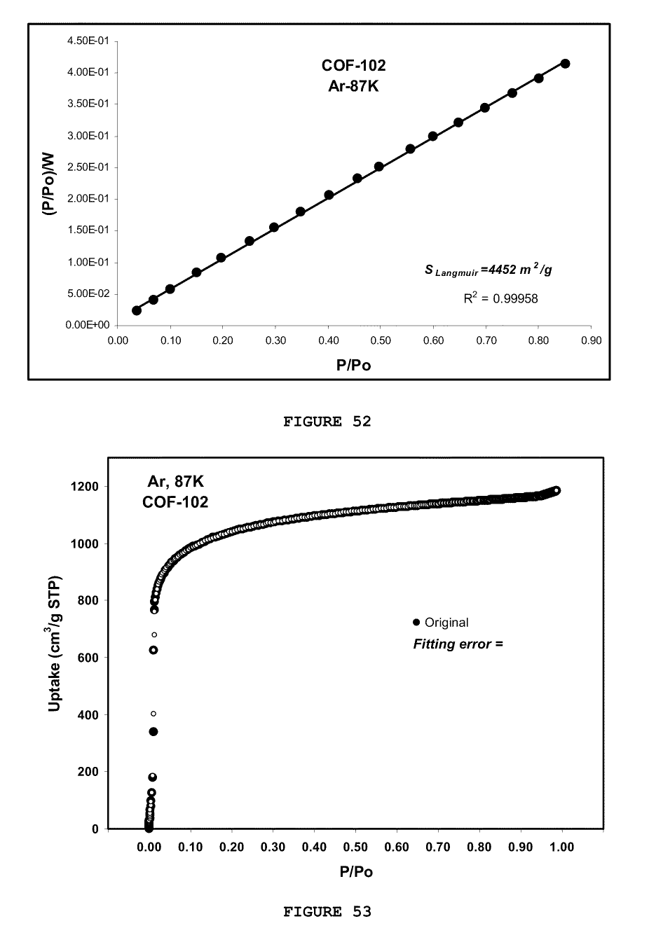

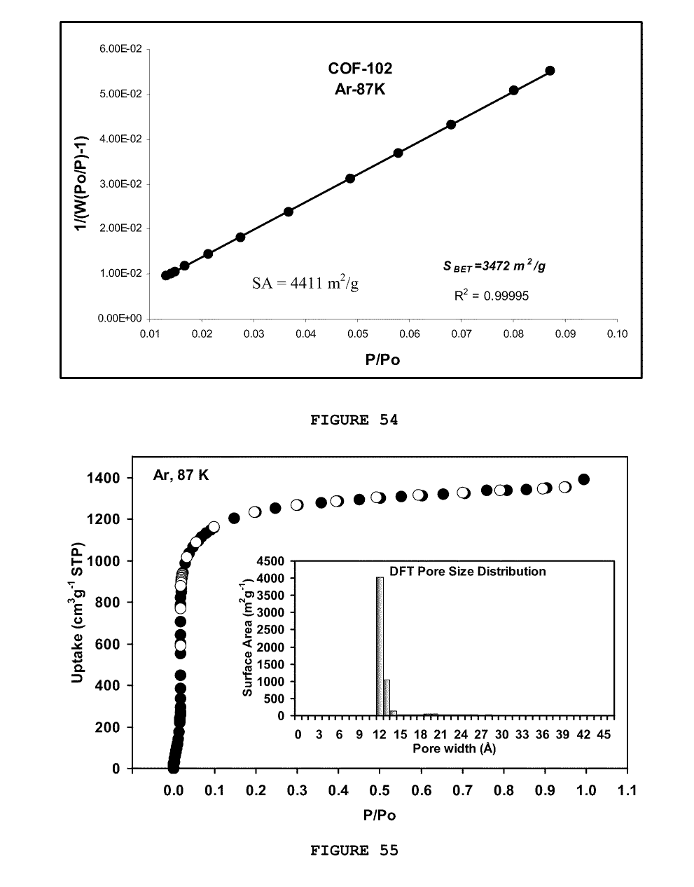

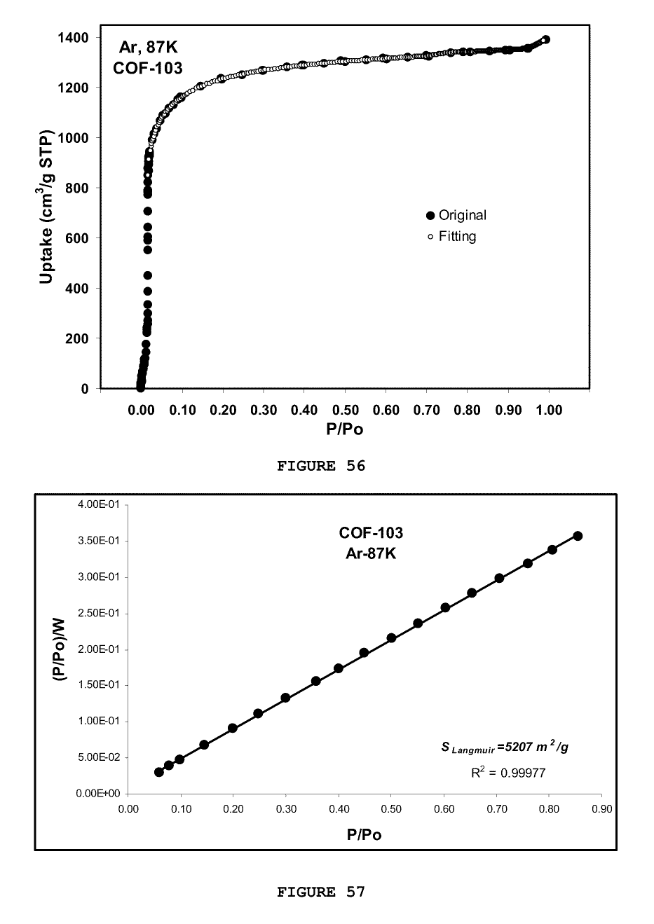

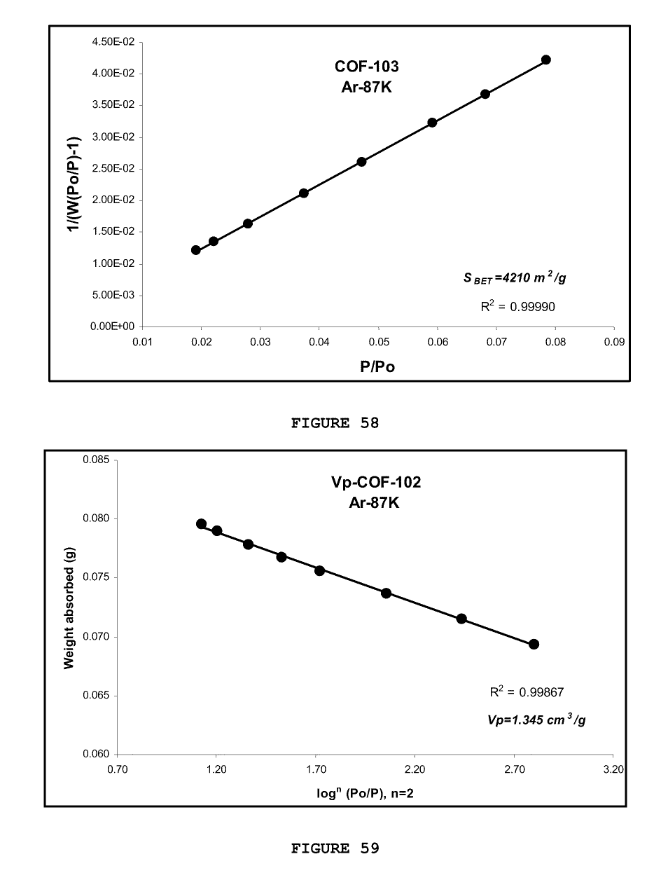

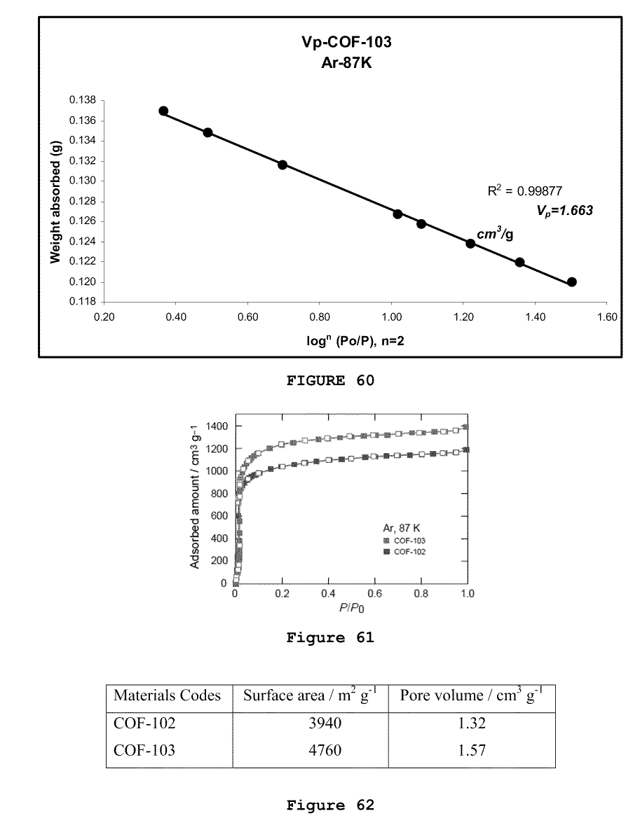

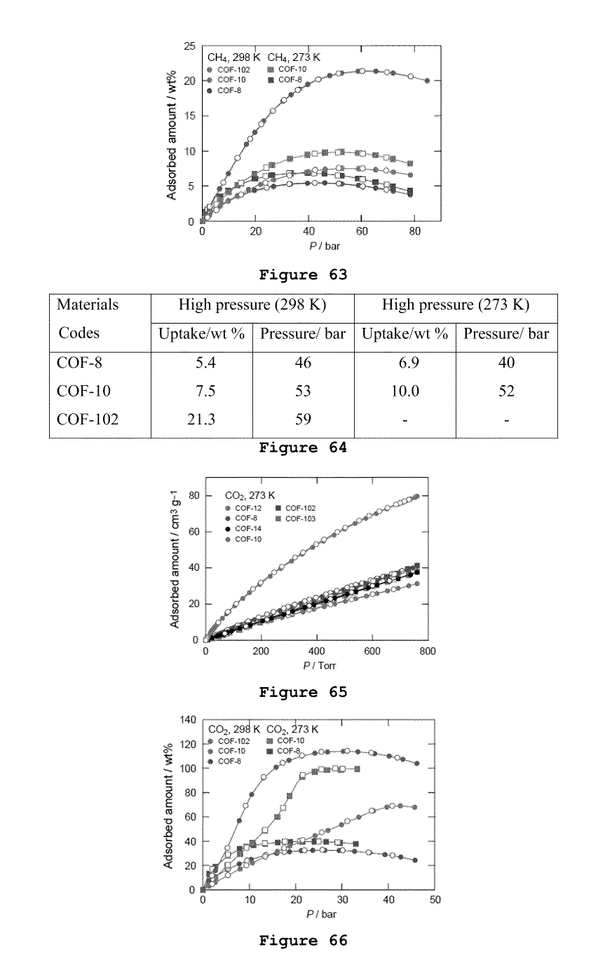

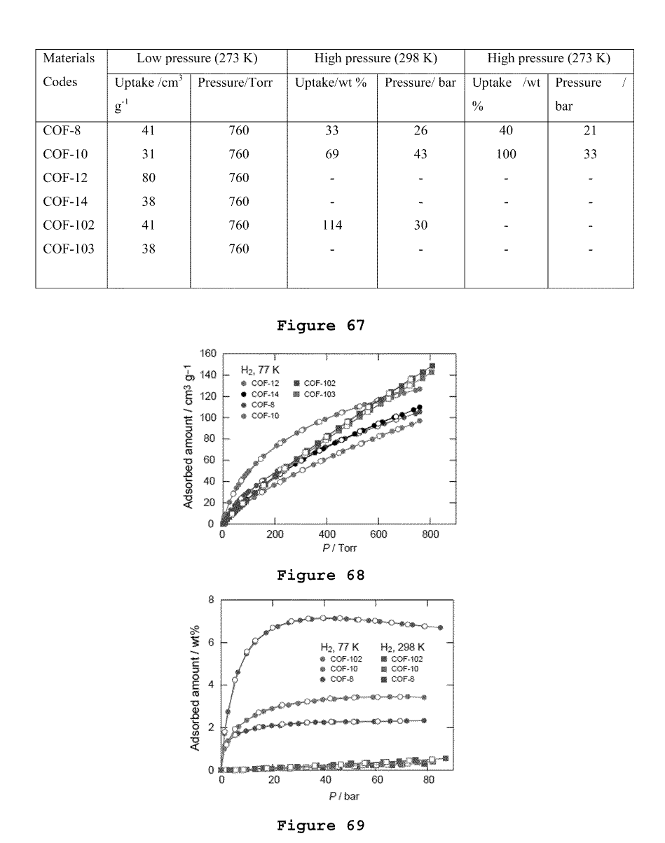

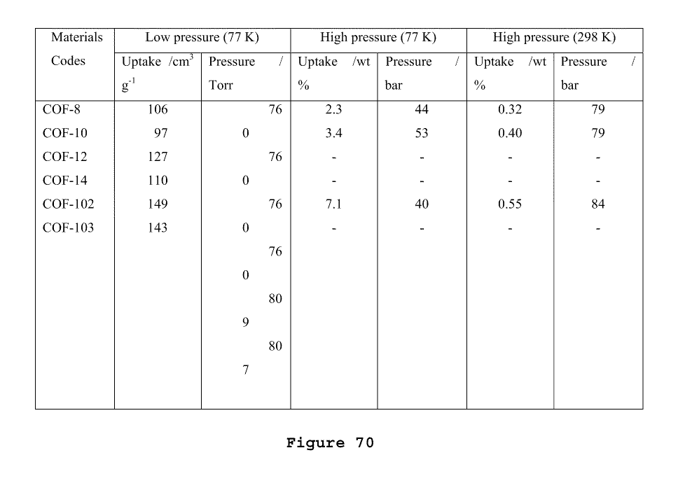

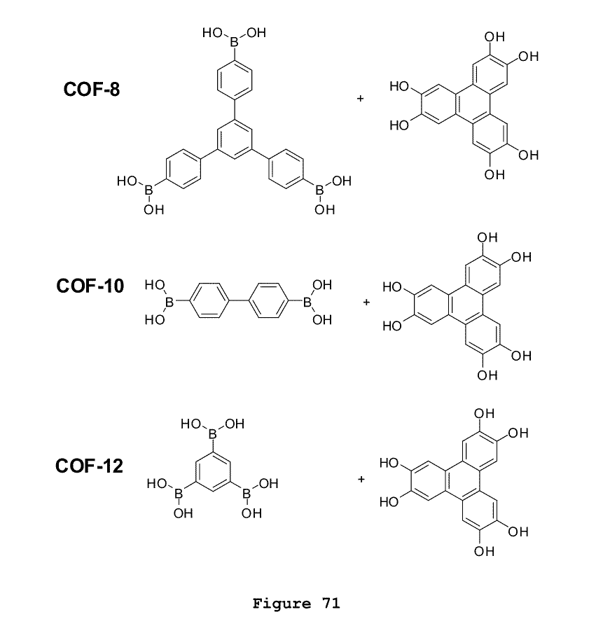

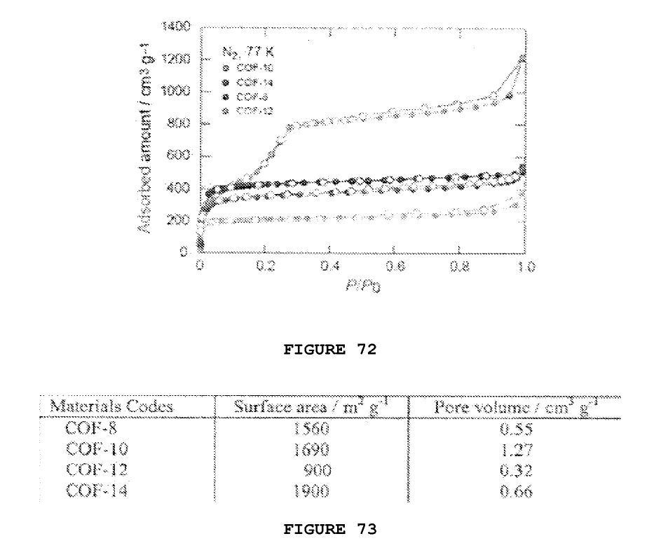

The low densities coupled with the maximized fraction of surface sites in 3-D COFs naturally impart their exceptional porosities, which were shown, for example, using gas adsorption studies on evacuated samples of COF-102 and COF-103. Samples of “as-synthesized” COF-102 and COF-103 were immersed in anhydrous tetrahydrofuran to remove solvent and starting materials included in the pores during synthesis, then placed under dynamic vacuum (10⁻⁵ Torr) for 12 h at 60° C. to completely evacuate the pores. Thermogravimetric analysis confirmed that all guests were removed from the pores and revealed the thermal stability of all COFs beyond 450° C. (FIG. 47-50). Argon isotherms for COF 102 and -103 were recorded at 87 K from 0-760 Torr (FIG. 4A, B). COF-102 and COF-103 exhibit a classic Type I isotherm characterized by a sharp uptake at the low pressure region between P P_{c}⁻¹=1×10⁻⁵-1×10⁻¹. The apparent surface areas calculated using the Brunauer-Emmett-Teller (BET) model were found to be 3472 and 4210 m² g⁻¹ for COF-102 and -103, respectively. The pore volume determined using the Dubinin-Radushkevich (DR) equation afforded values of 1.35 cm³ g⁻¹ (COF-102) and 1.66 cm³ g⁻¹ (COF-103). It is noteworthy that BET surface areas of COFs exceed porous carbons (2400 m² g⁻¹), silicates (1,300 m² g⁻¹), recently reported 2-D COFs (1590 m² g⁻¹), polymers of intrinsic microporosity (PIMs) (1064 m² g⁻¹), polymer resins (2090 m² g⁻¹) and stand with the highest surface areas of MOFs (MOF-177: 4500 m² g⁻¹). Calculation of pore-size obtained from appropriately fitting density functional theory (DFT) models to the isotherms (FIGS. 52 and 56) yielded pore size distributions of COF-102 (11.5 Å, FIG. 4A inset) and COF-103 (12.5 Å, FIG. 4B inset). Narrow distributions are obtained and are centered at values close to the pore diameters obtained from the crystal structures. Experiments are underway to study the porosity of COF-105 and -108 which are expected to have equally remarkable porosities. 3-D COFs are anticipated to be the first members of a large class of porous materials potentially as extensive in its variety and applications as zeolites and MOFs.

In one embodiment of the disclosure, a gas storage material comprising a covalent-organic framework is provided. Advantageously, the covalent-organic framework includes one or more sites for storing gas molecules. Gases that may be stored in the gas storage material of the disclosure include gas molecules comprising available electron density for attachment to the one or more sites on the surface are of a pore or interpenetrating porous network. Such electron density includes molecules having multiple bonds between two atoms contained therein or molecules having a lone pair of electrons. Suitable examples of such gases include, but are not limited to, the gases comprising a component selected from the group consisting of ammonia, argon, carbon dioxide, carbon monoxide, hydrogen, and combinations thereof. In a particularly useful variation the gas storage material is a hydrogen storage material that is used to store hydrogen (H2). In another particularly useful variation, the gas storage material is a carbon dioxide storage material that may be used to separate carbon dioxide from a gaseous mixture.

In a variation of this embodiment, the gaseous storage site comprises a pore in a COF. In a refinement, this activation involves removing one or more chemical moieties (guest molecules) from the COF. Typically, such guest molecules include species such as water, solvent molecules contained within the COF, and other chemical moieties having electron density available for attachment.

The covalent-organic frameworks provided herein include a plurality of pores for gas adsorption. In one variation, the plurality of pores has a unimodal size distribution. In another variation, the plurality of pores have a multimodal (e.g., bimodal) size distribution.

Sorption is a general term that refers to a process that results in the association of atoms or molecules with a target material. Sorption includes both adsorption and absorption. Absorption refers to a process in which atoms or molecules move into the bulk of a porous material, such as the absorption of water by a sponge. Adsorption refers to a process in which atoms or molecules move from a bulk phase (that is, solid, liquid, or gas) onto a solid or liquid surface. The term adsorption may be used in the context of solid surfaces in contact with liquids and gases. Molecules that have been adsorbed onto solid surfaces are referred to generically as adsorbates, and the surface to which they are adsorbed as the substrate or adsorbent. Adsorption is usually described through isotherms, that is, functions which connect the amount of adsorbate on the adsorbent, with its pressure (if gas) or concentration (if liquid). In general, desorption refers to the reverse of adsorption, and is a process in which molecules adsorbed on a surface are transferred back into a bulk phase.

Although it is known that porous compounds adsorb guest molecules, the mechanism of adsorption is complicated. For the fundamental studies developments of a new class of materials whose structure are well organized are prerequisites, because one needs to consider specific interaction between adsorbent and adsorptive. Recently discovered crystalline porous materials of COFs are good candidates to acquire general knowledge systematically. That is, not only apparent surface area and pore volume but also pore size distribution and adsorption sites needs to be analyzed by use of Ar isotherms.

Two COFs have been examined as standards for Ar storage materials. Since these compounds possess various pore diameters and functionalities, systematic studies on Ar sorption behavior should be possible. Gas sorption isotherms were taken under low pressure region (up to 760 Torr) at 87 K.

These materials would be used as standard compounds for sorption instruments, and obtained results would be helpful to improve various industrial plants (i.e. separation or recovery of chemical substance).

The advantage of COFs over well studied activated carbons is related to the robust porous structures and the ease to functionalize the pore and surface by choosing appropriate organic linkers and/or metal ions. Collected data should be applicable to DFT calculation to estimate pore size distribution, which is attractive method in isotherm analyses.

The ability of gas sorption has been examined by measuring Ar isotherms, and several materials are already synthesized in gram scale order successfully.

These materials and theoretical knowledge should be desired by chemical industry companies who are running gas separation and storage systems.

In one embodiment, the materials provided herein may be used for methane storage and purification of natural gases. The advantage of COFs over well studied activated carbons is related to the robust porous structures and the ease to functionalize the pore and surface by choosing appropriate organic linkers. Improvements in this invention are that i) optimized pore size for CH₄ sorption has been discovered and ii) functionalized compounds show good sorption capacities. These discoveries will lead COFs to become more selective and more efficient gas sorption and purification adsorbents. The ability of gas sorption has been examined by measuring CH₄ isotherms under wide range pressure. Some compound showed high capacity rather than zeolite 13× and MAXSORB (carbon powder) which are widely used as adsorbents or separation agents.

These materials should be desired by companies who wish to have new porous materials for gas storage and separation, because these materials have optimized pore structures and/or functionalized pore systems which are important factors to control affinity with CH₄ molecules. Indeed, appropriate affinity between CH₄ and adsorbents should be effective for purification of natural gas without poisoning of the materials' surface.

In another embodiment, the materials may be used for gas storage and separation. The advantage of COFs over well studied activated carbons and zeolites is related to the robust porous structures and the ease to functionalize the pore and surface by choosing appropriate organic linkers and/or metal ions. Improvements in this invention are that i) optimized pore size for CO₂ sorption has been discovered and ii) functionalized compounds show good sorption capacities. These discoveries will lead COFs to become more selective and more efficient gas sorption and separation adsorbents. Provided herein are porous Covalent Organic Frameworks (COFs) having functionalized pore, high surface area, and high chemical and thermal stability as adsorbents for reversible carbon dioxide storage. Considering that removal of CO₂ (i.e. green house gas) is an important issue from the environmental points of view, development of feasible CO₂ storage materials is pressing issue.

These materials should be desired by companies who wish to have new porous materials for gas storage and separation, because these materials have optimized pore structures and/or functionalized pore systems which are important factors to control affinity with CO₂ molecules. Indeed, appropriate affinity between CO₂ and adsorbents should be effective for removal of CO₂ without poisoning of the materials' surface.

Provided herein are porous Covalent Organic Frameworks (COFs) having functionalized pore, high surface area, and high chemical and thermal stability as adsorbents for reversible hydrogen storage. These materials could be widely applicable to store significant amounts of H₂ in a safe and practical way.

In another embodiment, the materials may be used in an H₂ tank for hydrogen-powered fuel cells.

The advantage of COFs over well studied activated carbons is related to the robust porous structures and the ease to functionalize the pore and surface by choosing appropriate organic linkers and/or metal ions. Improvements in this invention are that i) optimized pore size for H₂ sorption has been discovered and ii) functionalized compounds show good sorption capacities. These discoveries will lead COFs to become more selective and more efficient H₂ storage materials.

These materials should be desired by car companies who wish to have new porous materials for H₂-powered fuel cells.

The disclosure also provide chemical sensors (e.g. resistometric sensors) capable of sensing the presence of an analyte of interest. There is considerable interest in developing sensors that act as analogs of the mammalian olfactory system. However, may such sensor systems are easily contaminated. The porous structures of the disclosure provide a defined interaction area that limits the ability of contaminate to contact a sensor material the passes through the porous structure of the covalent organic framework on the disclosure. For example, various polymers are used in sensor systems including conductive polymers (e.g., poly(anilines) and polythiophenes), composites of conductive polymers and non-conductive polymers and composites of conductive materials and non-conductive materials. In resistometric systems conductive leads are separated by the conductive material such that a current traverse between the leads and through the sensor material. Upon binding to an analyte, the resistance in the material changes and detectable signal is thus generated. Using the COFs of the disclosure, the area surrounding the sensor material is limited and serves as a “filter” to limit contaminants from contacting the sensor material, thus increasing sensor specificity.

The following non-limiting examples illustrate the various embodiments provided herein. Those skilled in the art will recognize many variations that are within the spirit of the subject matter provided herein and scope of the claims.

### Examples

Reticular chemistry was successful used to synthesize and characterize of 3-D COFs. The tetrahedral building blocks A and B, and the triangular, C, were chosen because they are rigid and unlikely to deform during the assembly reaction.

Dehydration reactions of these units produce triangular B₃O₃ rings, D, and C₂O₂B rings, E (FIG. 1). Based on these building blocks, the disclosure provides at least two kinds of reactions in which A or B undergo self-condensation or co-condensation with C to give COF structures based on nets with both tetrahedral and triangular nodes (FIGS. 1D and E). However, in principle there is an infinite number of possible nets that may result from linking tetrahedra with triangles. The most symmetric nets are the most likely to result in an unbiased system, and more particularly, those with just one kind of link will be preferred and are thus the best to target. In the present case of linking tetrahedral and triangular building blocks, the only known nets meeting the above criteria are those with symbols ctn and bor (FIG. 1F, G). The nodes of the nets are therefore replaced by the molecular building units with tetrahedral and triangular shapes (FIG. 1H, I). It is important to note that using rigid, planar triangular units such as B₃O₃ rings requires that rotational freedom exist at the tetrahedral nodes for the 3-D structures ctn and bor to form.

Cerius² was used to draw the ‘blueprints’ for synthesis of COFs based on ctn and bor nets by fitting molecular building blocks A and B on the tetrahedral nodes, and C and D on the triangular nodes of these nets adhering to their respective cubic space group symmetries, I 4̅3d (ctn) and P 4̅3m (bor). Energy minimization using force-field calculations was performed to produce the models where all bond lengths and angles were found to have chemically reasonable values.

Synthesis of the COFs was carried out according to the plan described above. Either TBPM or TBPS was suspended in mesitylene/dioxane and placed in partially evacuated (150 mTorr) Pyrex tubes, which were sealed and heated (85° C.) for 4 days to give white crystalline COF-102 and COF-103 in 63 and 73% yield, respectively. Similarly, co-condensation of TBPM or TBPS with HHTP (3:4 molar ratio) produces green crystalline solids of COF-105 (58% yield) and COF-108 (55% yield). The colors of COF-105 and COF-108 arise from possible inclusion of a small amount of highly colored oxidized HHTP in their pores.

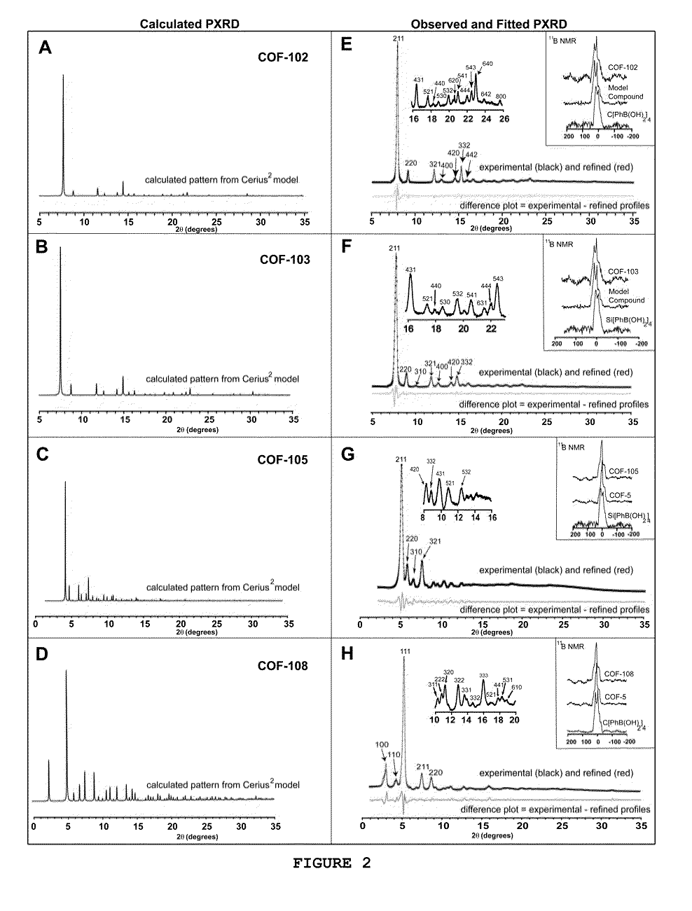

To prove that the products of synthesis are indeed covalently linked into the designed structures, the materials were studied by X-ray diffraction, spectroscopy, microscopy, elemental microanalysis, and gas adsorption. Firstly, comparison of PXRD patterns of modeled COFs (FIG. 2, A-D) to those observed for the products of synthesis (FIG. 2, E-H) reveal that they are indeed the expected COFs with ctn or bor type. The observed PXRD patterns display narrow line widths and low signal-to-noise ratios indicative of the high crystallinity of COFs. A remarkable degree of correspondence between peak positions and intensities is also observed substantiating that the H, B, C, O atomic composition and positions in the respective modeled unit cells are correct. The PXRD data of the COFs could also be indexed yielding unit cell parameters nearly identical to those calculated from Cerius² (Table S5). To further verify the unit cell parameters, PXRD patterns were subjected to model-biased Le Bail full pattern decomposition to extract the structure factor (F_{obs}) amplitudes from the X-ray data. All peaks experience some broadening because COF crystallites have micrometer dimensions. After accounting for line broadening in the initial stages of Le Bail extractions, fitting of the experimental profiles readily converged with refinement of the unit cell parameter. Refinements for all structures led, again, to values nearly identical to those calculated from Cerius² (Table S5). A near equivalence and low uncertainity (estimated standard deviation, Table S5) between calculated and refined cell parameters in addition to the facile and proper fit of the refined profiles, as indicated by statistically acceptable residual factors (Table S6), support that the COF structures are indeed those identified through modeling (FIG. 2; atomic coordinates: Table S1-S4).

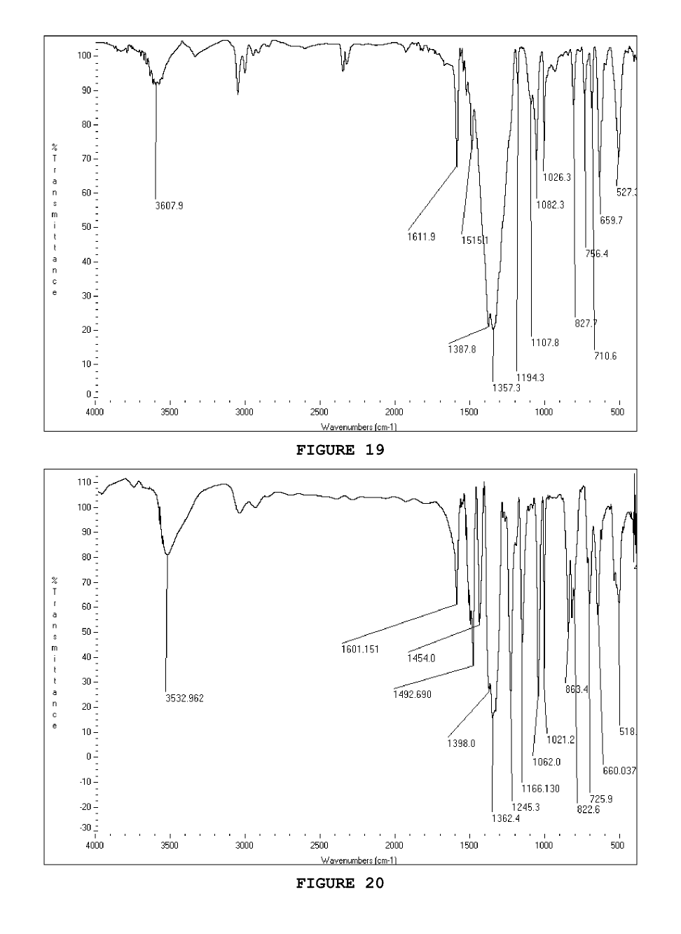

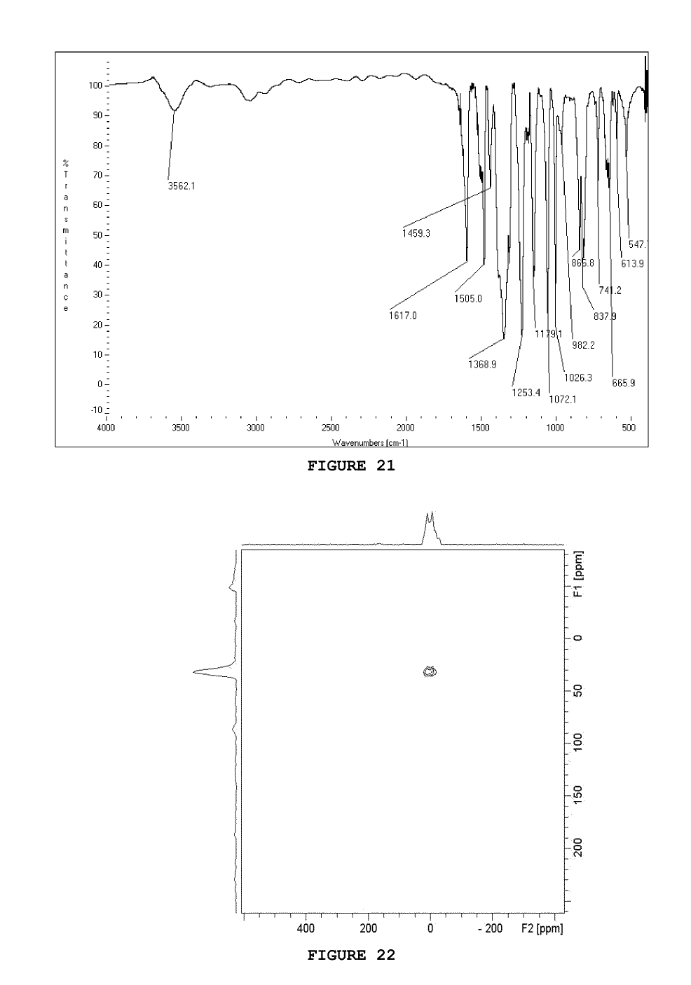

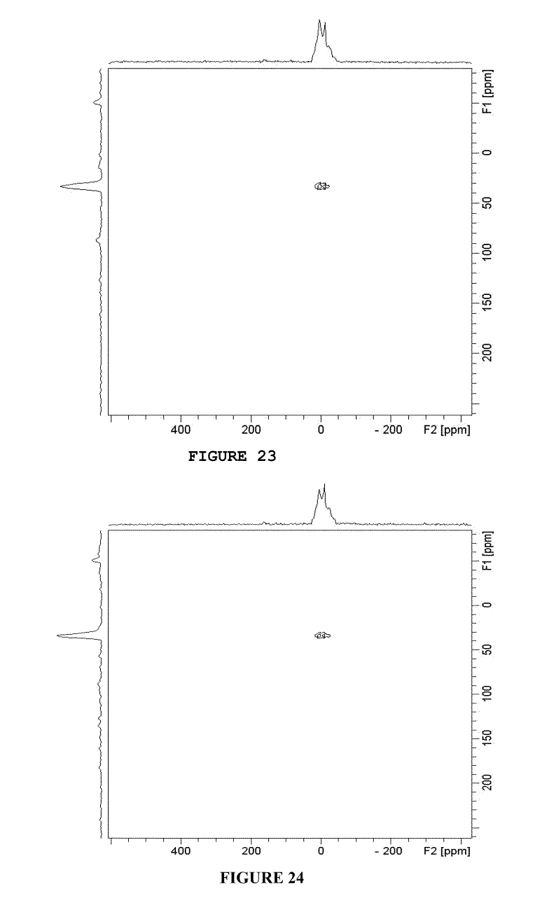

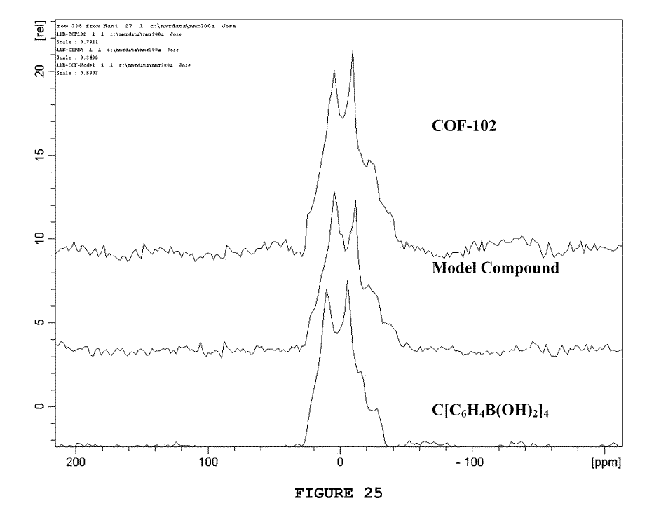

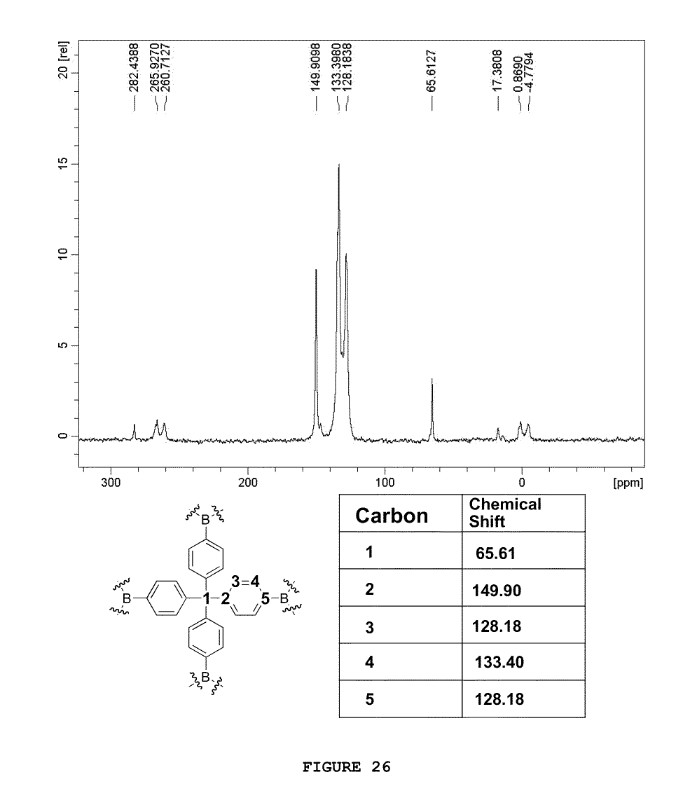

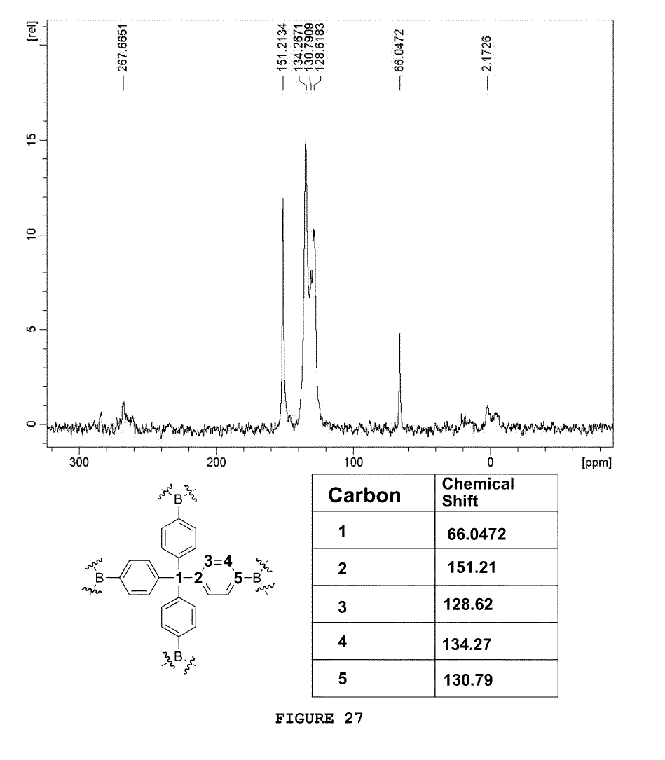

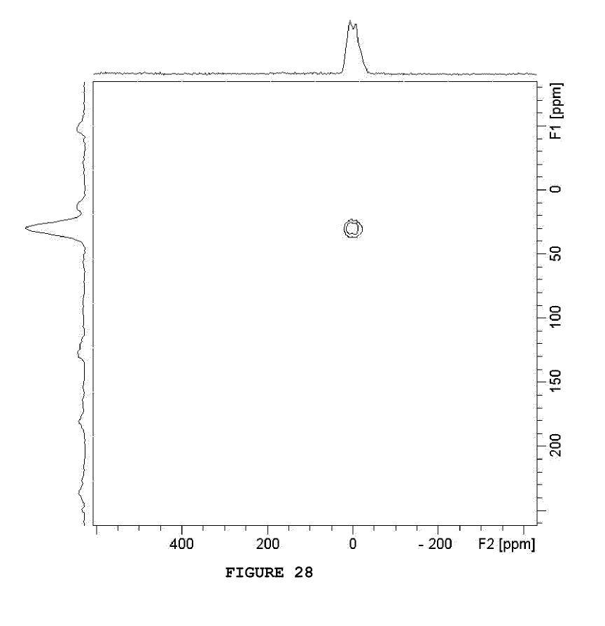

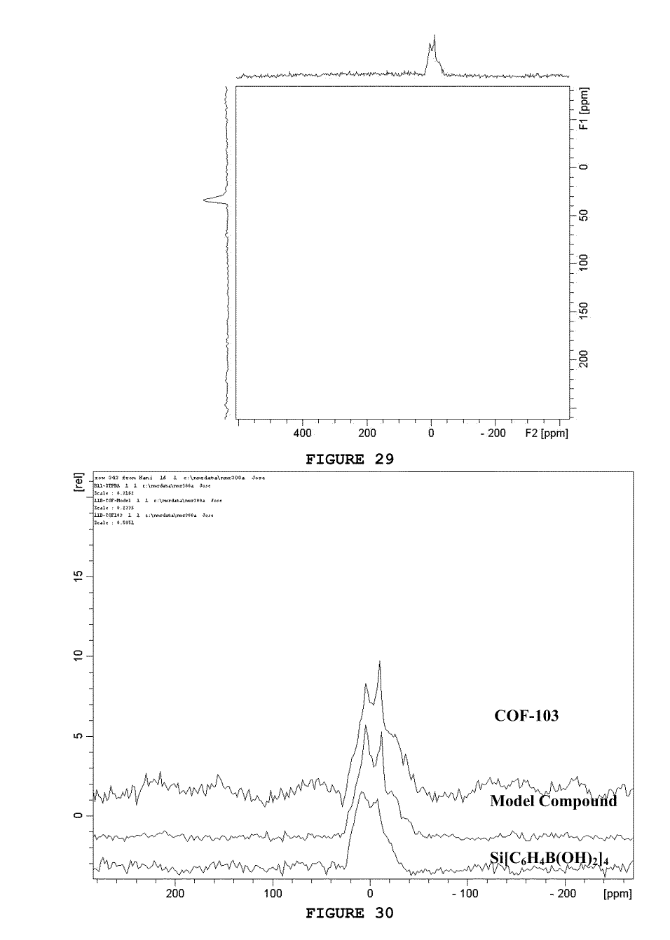

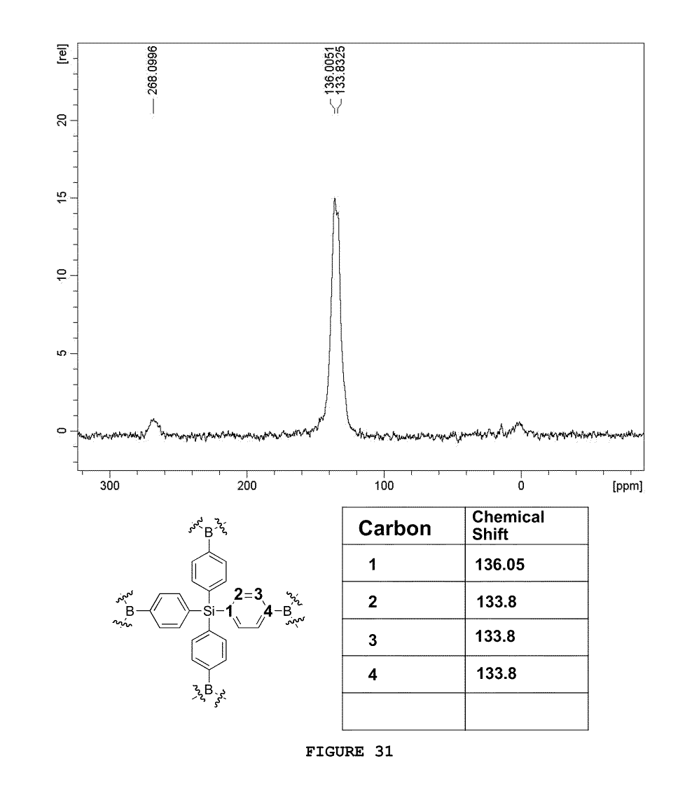

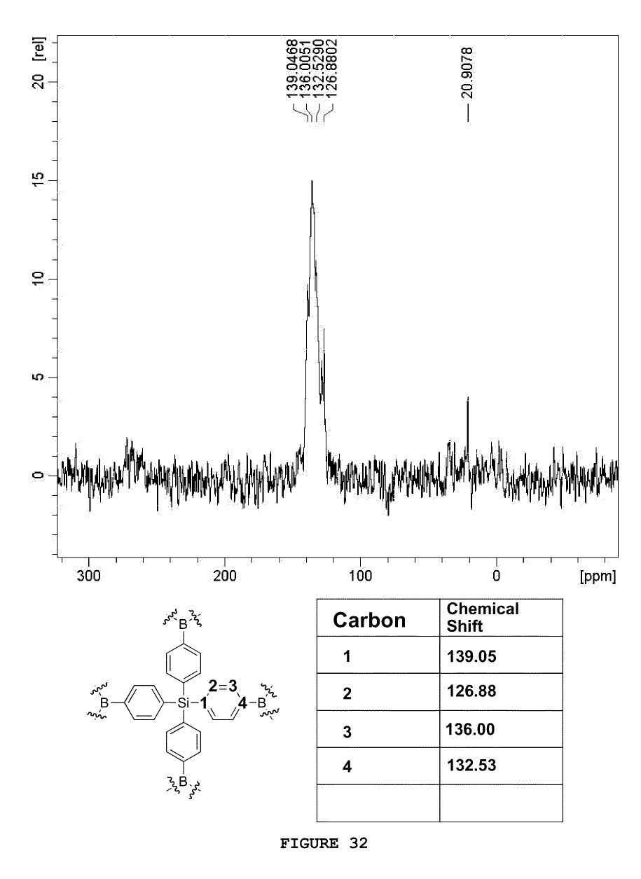

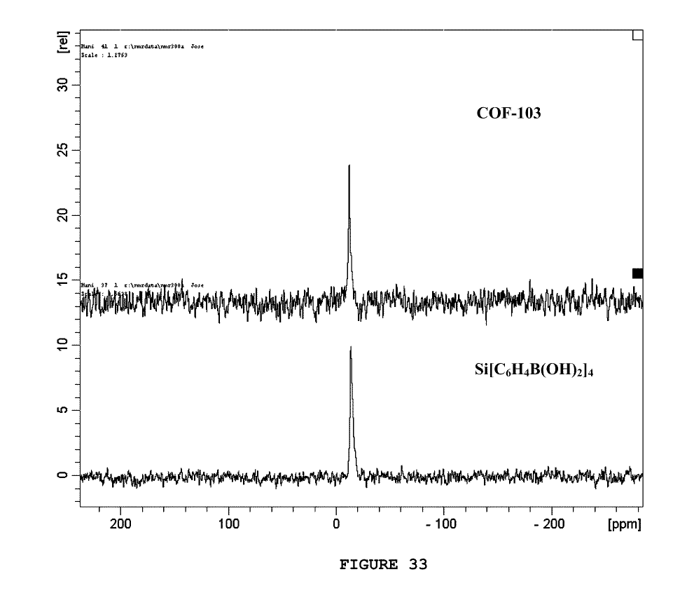

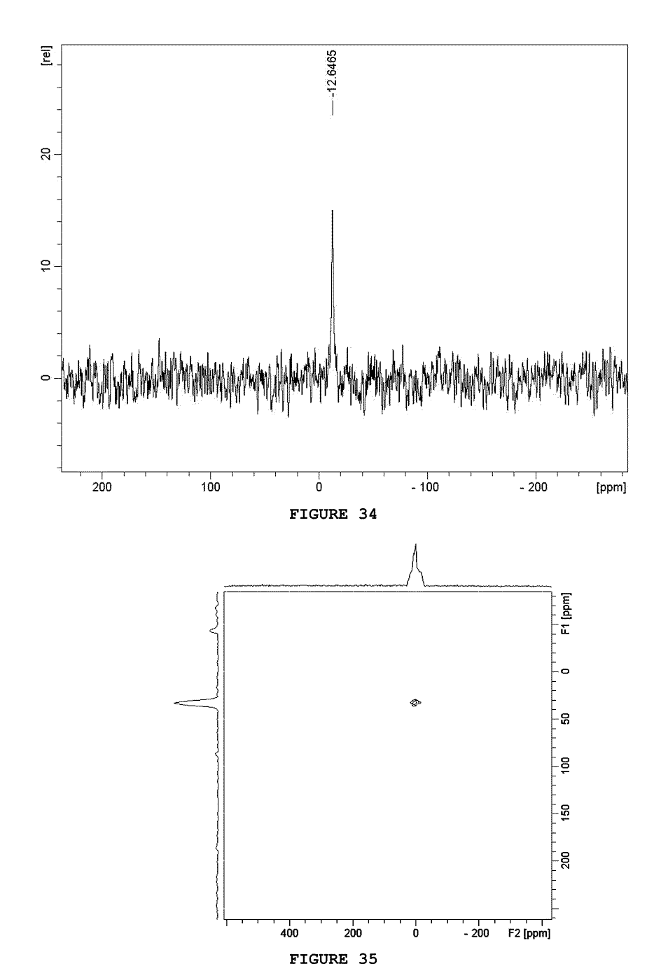

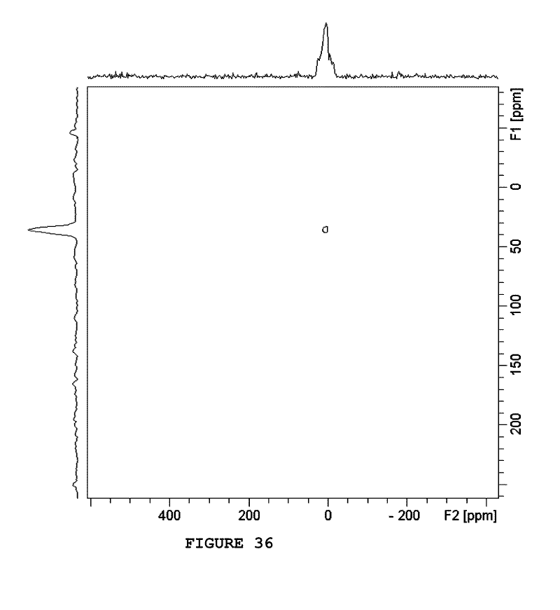

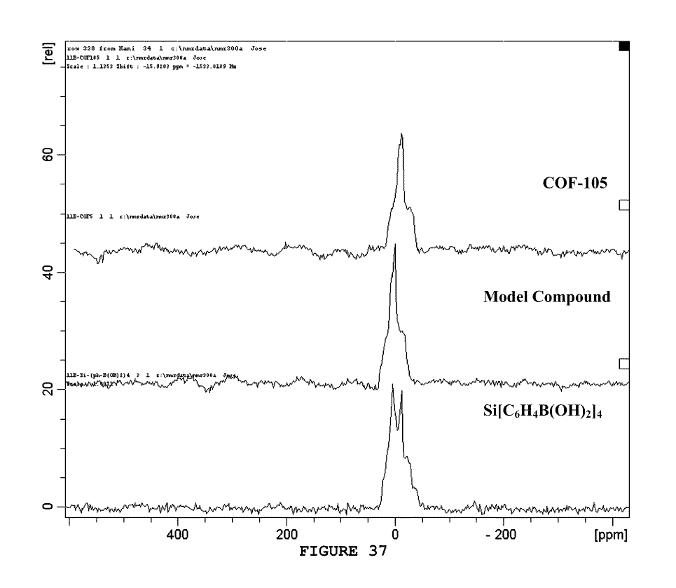

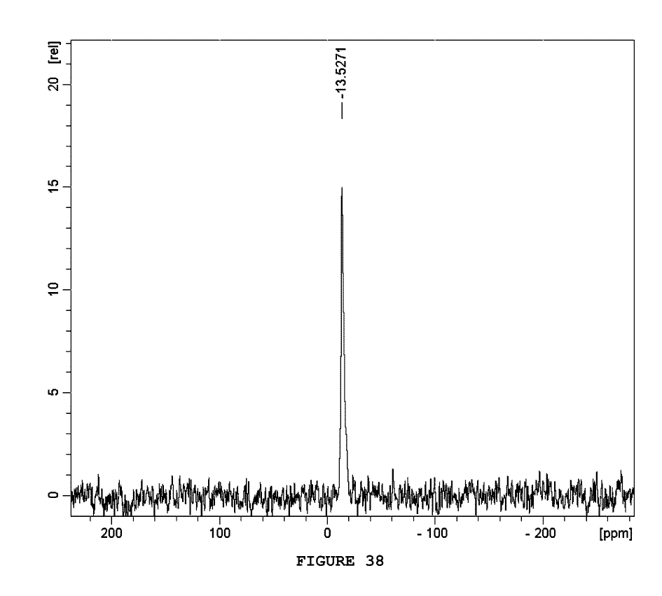

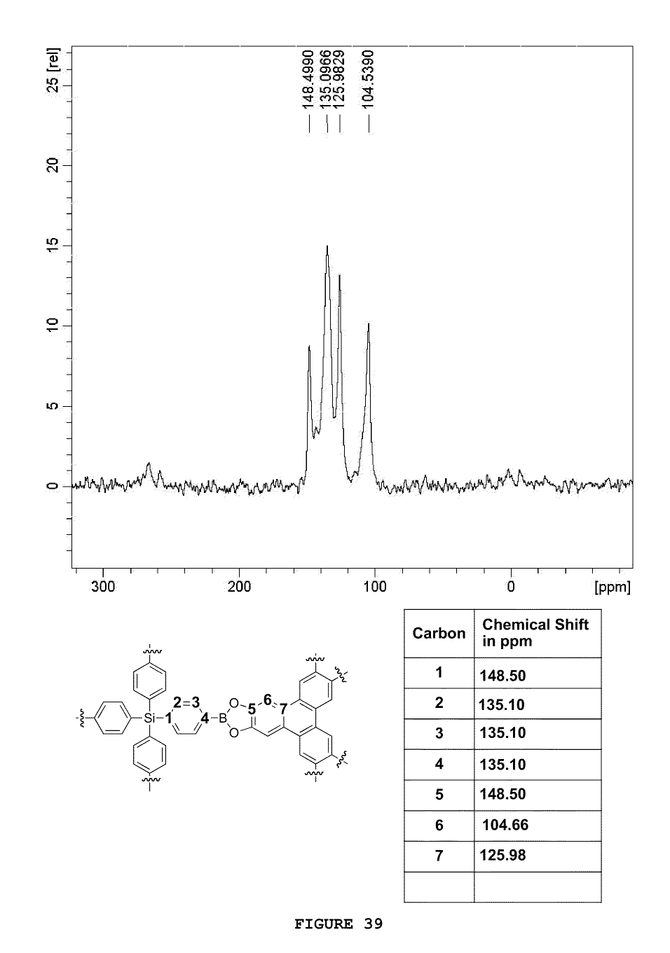

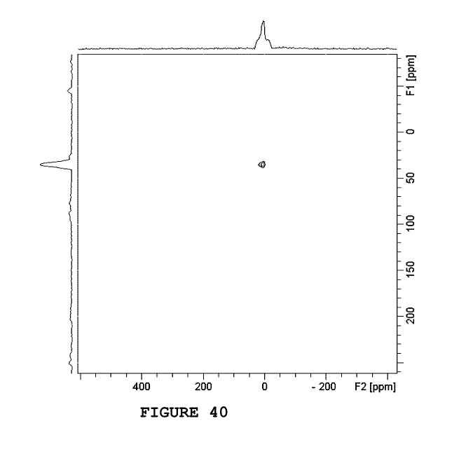

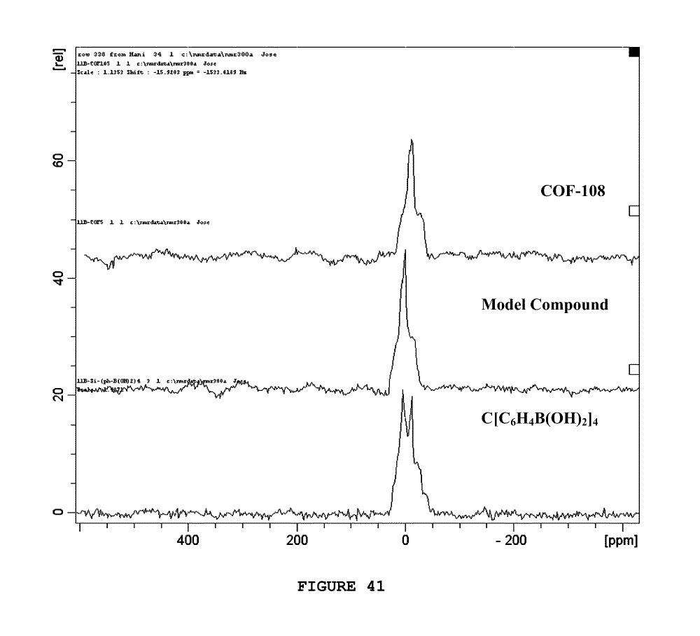

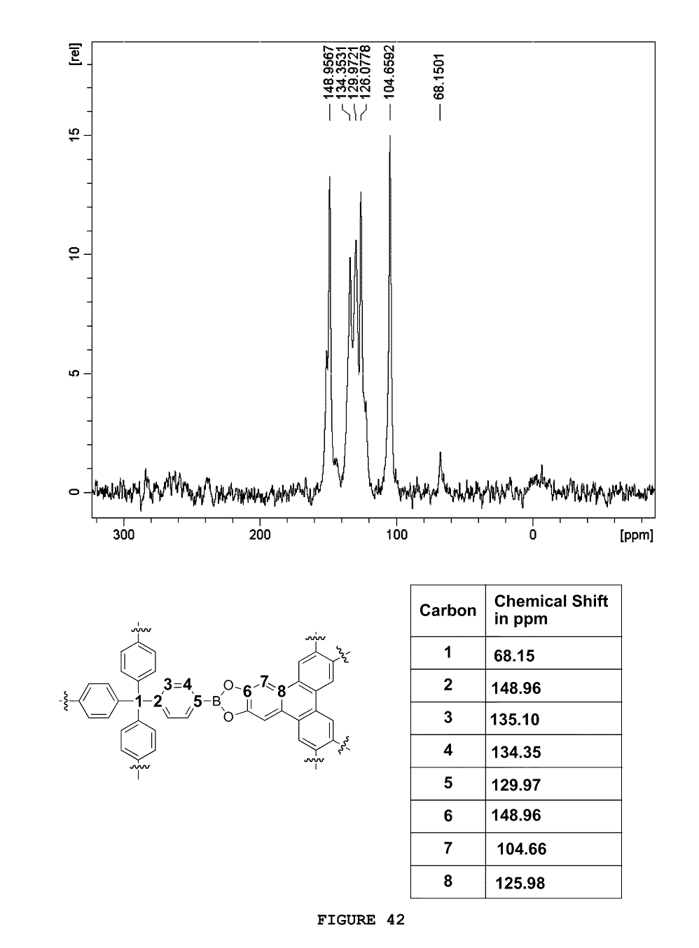

The covalent linking of building blocks through expected 6-membered B₃O₃ boroxine or 5-membered C₂O₂B boronate ester rings in the COFs was assessed using Fourier-transform infrared (FT-IR) and multiple-quantum magic-angle spinning nuclear magnetic resonance (MQ MAS-NMR) spectroscopies. FT-IR spectra of all COFs contain strongly attenuated bands arising from boronic acid hydroxyl groups indicating successful condensation of the reactants (FIG. 18-20). COFs prepared from self-condensation reactions all exhibit the diagnostic band at 710 cm⁻¹ for the out-of-plane deformation mode of boroxine rings. Co-condensed COF-105 and COF-108 products have strong C—O stretching bands at 1245 cm⁻¹ (COF-105), and 1253 cm⁻¹ (COF-108); signals distinctive for boronate ester five-membered rings. These FT-IR data are fingerprints for the expected boron-containing rings, however solid state ¹¹B MQ MAS-NMR spectroscopy is highly sensitive to the immediate bonding environment of boron. Any differences in B—C and B—O distances and/or angles will result in a notable change in the lines shape and intensity of the spectra. The acquired ¹¹B MQ MAS-NMR spectra for evacuated COFs were compared to those of molecular model compounds and starting materials (FIG. 2, E-H inset). The spectra of all COFs are coincident to those of the model compounds and are different from the starting materials. Thus, the boron-containing units in all the COFs have not only formed, but are perfectly formed B₃O₃ and C₂O₂B rings. Additionally data from ¹³C and ²⁹Si MQ MAS-NMR experiments show the presence of the expected number and environment of each type of respective nucleus further substantiating the structural assignments (FIG. 22-42).

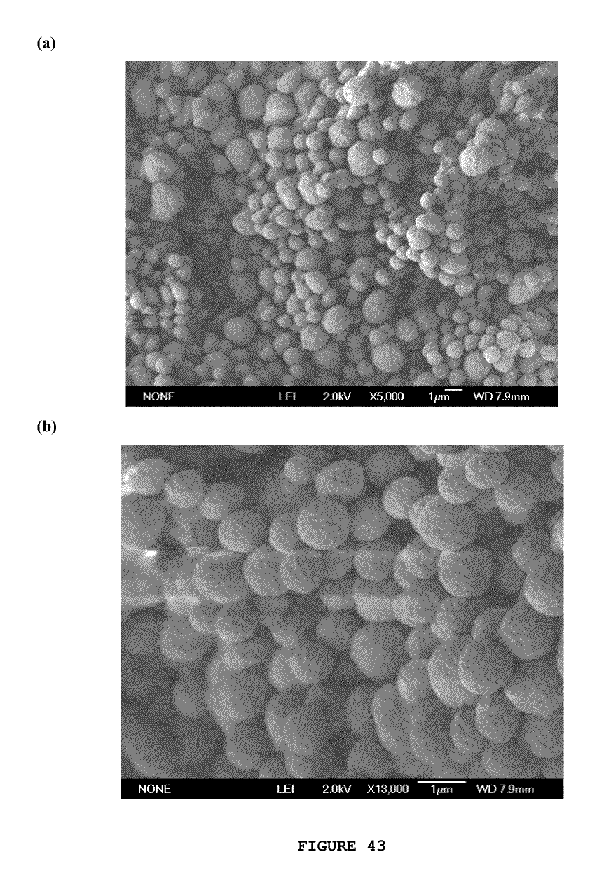

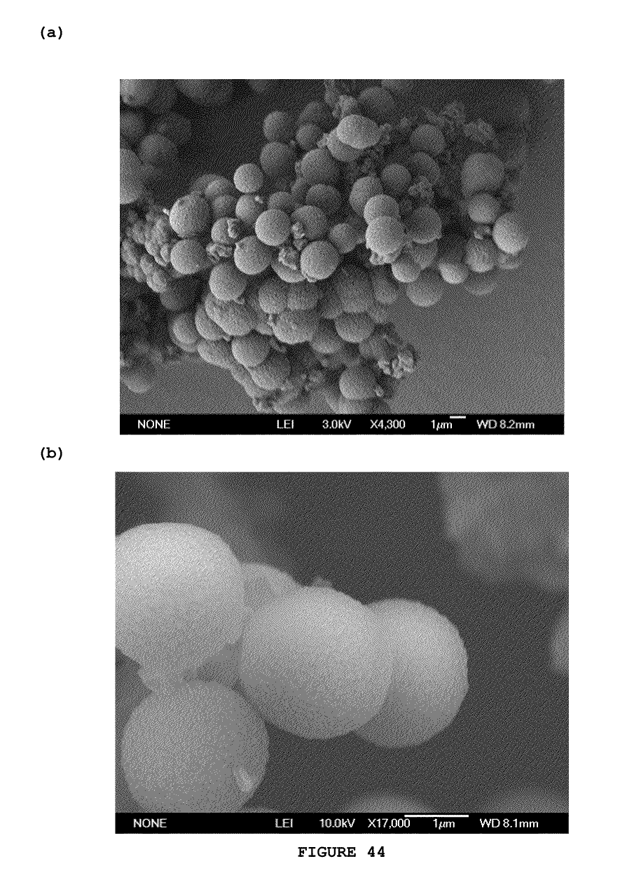

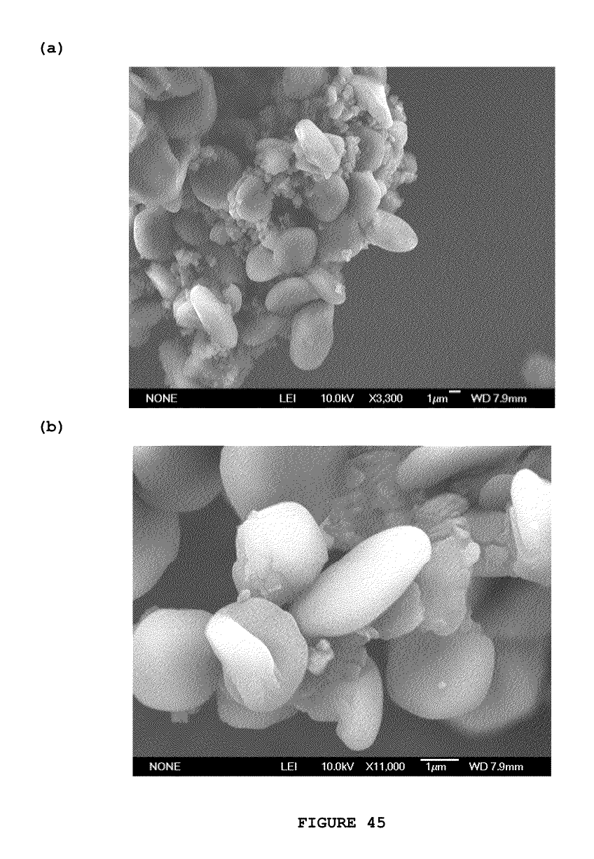

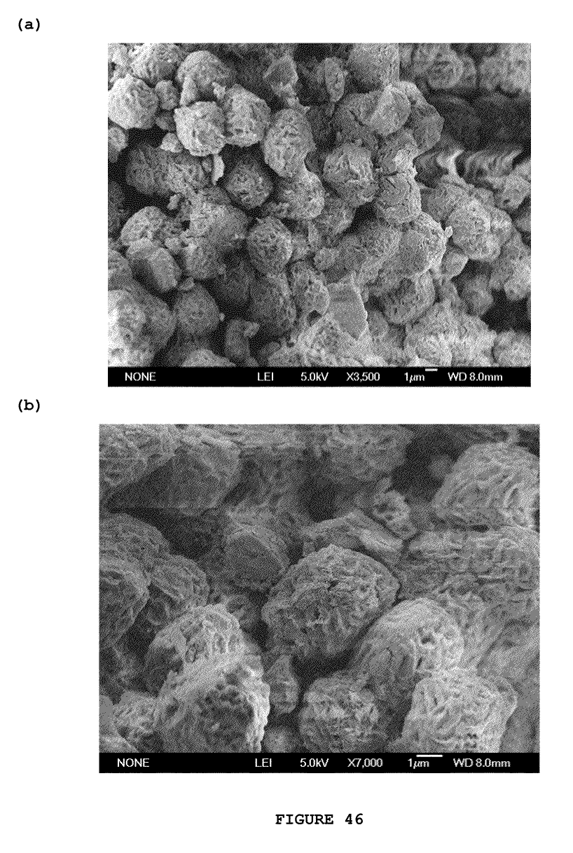

In order to establish the phase purity and synthetic reproducibility of the COF materials, multiple samples were exhaustively imaged using scanning electron microscopy (SEM). The SEM images of COF-102 and COF-103 revealed agglomerated and nonagglomerated 1-2 μm diameter spheres, respectively (FIG. 43-44). This morphology is likely caused by a polar hydroxylated (—OH) surface that causes spherical crystal growth to minimize interfacial surface energy with the relatively non-polar solvent media. SEM images recorded for COF-105 and -108 revealed 5 μm platelets and 3-4 um irregular spheres respectively (FIG. 45-46). For each of the COFs, only one unique morphology was observed; ruling out the presence of impurity phases. Furthermore C, H elemental microanalysis confirmed that the composition of each COF corresponded to formulations predicted from modeling.

All materials were synthesized in a Pyrex tube measuring o.d.<i.d.=10×8 mm² charged with the appropriate reagents, flash frozen at 77 K (LN₂ bath), evacuated to an internal pressure of 150 mTorr, and flame sealed. Upon sealing the length of the tube was reduced to ca. 18 cm.

Synthesis of COF-102. Tetra(4-dihydroxyborylphenyl)methane (50.0 mg, 0.10 mmol) and 1.0 mL of a 1:1 (v:v) solution of mesitylene-dioxane were used. The reaction mixture was heated at 85° C. for 4 days to afford a white precipitate which was isolated by filtration over a medium glass frit and washed with anhydrous tetrahydrofuran (10 mL). The product was washed (activated) by immersion in anhydrous tetrahydrofuran (10 mL) for 8 h, during which the solvent was decanted and freshly replenished four times. The solvent was removed under vacuum at room temperature to afford COF-102 as a white powder (27.8 mg, 65%). Anal. Calcd. for (C₂₅H₁₆B₄O₄): C, 70.88; H, 3.81%. Found: C, 64.89; H, 3.76%.

Synthesis of COF-103. Reaction of tetra(4-dihydroxyborylphenyl)silane (55.0 mg, 0.10 mmol) in 1.5 mL of a 3.1 v/v solution of mesitylene/dioxane at 85° C. for 4 days afforded COF-103 as a white powder (37.0 mg, 73%) after purification by the described method above. Anal. Calcd. for (C₂₄H₁₆B₄O₄Si): C, 65.56; H, 3.67%. Found: C, 60.43; H, 3.98%.

Synthesis of COF-105. Treatment of tetra(4-dihydroxyborylphenyl)silane (26.0 mg, 0.05 mmol) with 2,3,6,7,10,11-hexahydroxy-triphenylene (23.8 mg, 0.07 mmol, TCI) in 1.0 mL of a 1/1 v/v solution of mesitylene/dioxane at 85° C. for 9 days afforded COF-105 as a green powder. The product was filtered over a medium glass frit and washed with anhydrous acetone (10 mL) then immersed in anhydrous acetone (20 mL) for 24 h, during which the activation solvent was decanted and freshly replenished twice. The solvent was removed under vacuum at room temperature to afford COF-105 (26.8 mg, 58% based on the boronic acid). Anal. Calcd. for (C₄₈H₂₄B₄O₈Si): C, 72.06; H, 3.02%. Found: C, 60.39; H, 3.72%.

Synthesis of COF-108. Treatment of tetra(4-dihydroxyborylphenyl)methane (25.0 mg, 0.05 mmol) with 2,3,6,7,10,11-hexahydroxytriphenylene (34.0 mg, 0.10 mmol, TCI) in 1.0 mL of a 1:2 v/v solution of mesitylene/dioxane at 85° C. for 4 days afforded COF-108 (30.5 mg, 55% based on the boronic acid) as a green powder after purification as described for COF-105. Anal. Calcd. for (C₁₄₇H₇₂B₁₂O₂₄): C, 75.07; H, 3.09%. Found: C, 62.80; H, 3.11%.

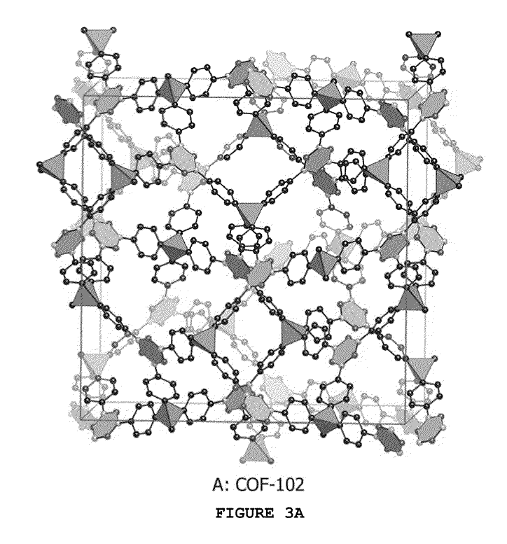

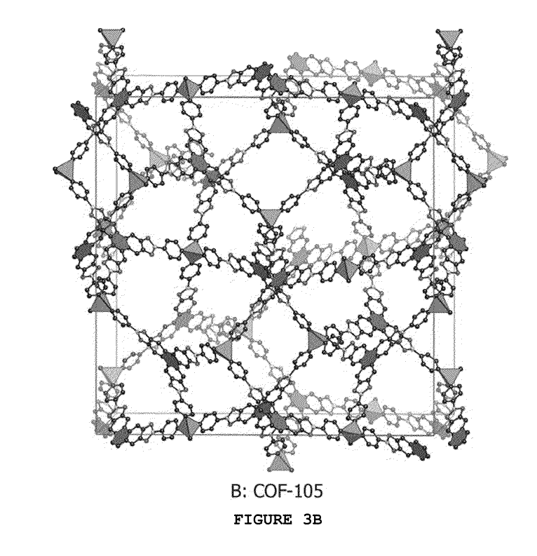

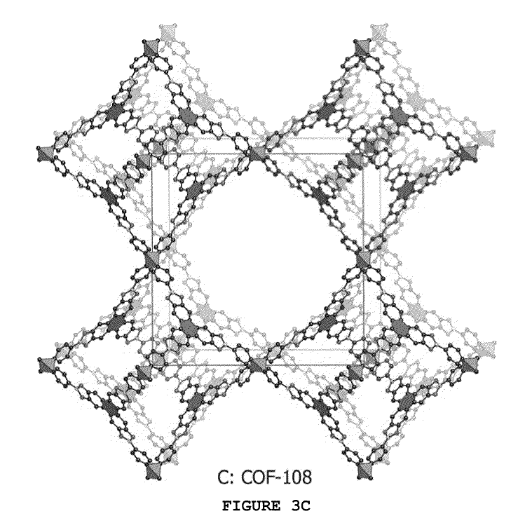

The derived structures for COF-102, -105, and -108 are shown in FIG. 3 (COF-103 has a tetrahedral Si replacing C and its structure is virtually identical to COF-102). COF-102 (FIG. 3A), COF-103, and COF-105 (FIG. 3B) are based on ctn and COF-108 (FIG. 3C) on bor. The only significant differences between the two type structures are that bor is about 15% less dense than ctn (compare the densities of COF-105 and COF-108) and has larger pores as discussed below. The three-coordinated vertices in both structures are constrained to be planar with 3-fold symmetry but the point symmetry at the tetrahedral site in ctn is only a subgroup ( 4̅=S₄) of that at the tetrahedral site in bor ( 4̅m²=D_{2d}) and this gives ctn less constraints and it could be a more strain-free structure.

It is also of interest to consider the pore sizes. In the COFs with ctn structure the center of the largest cavity in COF-102, -103 and -105 is 5.66, 5.98, and 10.37 Å from the nearest atoms (H). Allowing for a van der Waals radius of 1.2 Å for H this means that a sphere of diameter 8.9, 9.6, and 18.3 Å is available in these three COFs respectively. However the pores in these materials are far from spherical and one expects the effective pore size to be somewhat larger. COF-108 has two cavities and the atoms closest to the center are C atoms at 9.34 and 15.46 Å. Allowing for a van der Waals radius of 1.7 Å for C these cavities can accommodate spheres of 15.2 and 29.6 Å respectively. It may be seen that the larger pores are well above the lower limit (20 Å) for the material to be described as mesoporous and COF-108 is a rare example of a fully crystalline mesoporous material.

3-D COF Structural Models and Calculation of Simulated PXRD patterns. Cerius² Modeling (development of synthetic blueprint for 3-D COFs). All models were generated using the Cerius² chemical structure-modeling software suite employing the crystal building module. Carbon nitride structures were created by starting with the space group I 4̅3d, cell dimensions and vertex positions obtained from the Reticular Chemistry Structure Resource (http:˜˜okeeffe-ws1.1a.asu.edu/RCSR/home.htm) under the symbol ctn. The model of COF-102 was built from ctn by replacing the nitrogen (3-coordinate node) with the B₃O₃ (boroxine) unit positioning boron at each vertex of the triangle. Then the C—N bond in the structure was replaced by phenyl rings and the piecewise constructed structure was minimized using Universal Force Field (UFF) of Cerius². The model of COF-103 was created using the method described above except carbon was substituted with silicon. Likewise, COF-105 was built in a similar fashion to COF-103 except the 3-coordinate species was substituted by 2,3,6,7,10,11-hexadydroxytriphenylene (HHTP) with the boron of the triboronate ester defining the vertex of the triangular unit.

Boracite structures were created starting with the space group P 4̅3m, cell dimensions and vertex positions obtained from the Reticular Chemistry Structure Resource (http:˜˜okeeffe-ws1.1a.asu.edu/RCSR/home.htm) under the symbol bor. The model of COF-108 was created using the method described above except the B₃O₃ (boroxine) unit was replaced by the HHTP with the boron of the triboronate ester in each vertex of the triangle.

Positions of atoms in the respective unit cells are listed as fractional coordinates in Tables S1-S4. Simulated PXRD patterns were calculated from these coordinates using the PowderCell program. This software accounts for both the positions and types of atoms in the structures and outputs correlated PXRD patterns whose line intensities reflect the atom types and positions in the unit cells.

TABLE S1
Fractional atomic coordinates for COF-102
calculated from Cerius² modeling.
COF-102

| Space group symmetry | I 4̅3d | | |
|---|---|---|---|
| a = b = c = 27.4077 Å | | | |
| α = β = γ = 90° | | | |
| Atom | x | y | z |
| O1 | 0.7469 | 0.3030 | 0.8283 |
| B1 | 0.7378 | 0.3353 | 0.7868 |
| C1 | 0.7737 | 0.3790 | 0.7777 |
| C2 | 0.8072 | 0.3926 | 0.8137 |
| C3 | 0.7724 | 0.4049 | 0.7337 |
| C4 | 0.8395 | 0.4312 | 0.8058 |
| C5 | 0.8052 | 0.4430 | 0.7254 |
| C6 | 0.8404 | 0.4563 | 0.7607 |
| C7 | 0.8750 | 0.5000 | 0.7500 |

TABLE S2
Fractional atomic coordinates for COF-103
calculated from Cerius² modeling.
COF-103

| Space group symmetry | I 4̅3d | | |
|---|---|---|---|
| a = b = c = 28.4541 Å | | | |
| α = β = γ = 90° | | | |
| Atom | x | y | z |
| O1 | 0.4517 | 0.4998 | 0.4274 |
| B1 | 0.4205 | 0.4910 | 0.4673 |
| C1 | 0.3779 | 0.5250 | 0.4755 |
| C2 | 0.3492 | 0.5199 | 0.5153 |
| C3 | 0.3678 | 0.5606 | 0.4429 |
| C4 | 0.3297 | 0.5907 | 0.4500 |
| C5 | 0.3112 | 0.5502 | 0.5225 |
| C6 | 0.3014 | 0.5859 | 0.4901 |
| Si1 | 0.2500 | 0.6250 | 0.5000 |

TABLE S3
Fractional atomic coordinates for COF-105
calculated from Cerius² modeling.
COF-105

| Space group symmetry | I 4̅3d | | |
|---|---|---|---|
| a = b = c = 44.381776 Å | | | |
| α = β = γ = 90° | | | |
| Atom | x | y | z |
| O1 | 0.3833 | 0.7508 | 0.7643 |
| O2 | 0.3707 | 0.7972 | 0.7915 |
| B1 | 0.3909 | 0.7712 | 0.7891 |
| C1 | 0.4182 | 0.7660 | 0.8107 |
| C2 | 0.4359 | 0.7399 | 0.8081 |
| C3 | 0.4252 | 0.7873 | 0.8329 |
| C4 | 0.4496 | 0.7827 | 0.8523 |
| C5 | 0.4602 | 0.7353 | 0.8276 |
| C6 | 0.4671 | 0.7565 | 0.8499 |
| C7 | 0.3583 | 0.7655 | 0.7526 |
| C8 | 0.3513 | 0.7912 | 0.7678 |
| C9 | 0.3417 | 0.7561 | 0.7276 |
| C10 | 0.3267 | 0.8086 | 0.7596 |
| C11 | 0.3166 | 0.7736 | 0.7176 |
| C12 | 0.3083 | 0.7998 | 0.7348 |
| Si1 | 0.5000 | 0.7500 | 0.8750 |

TABLE S4
Fractional atomic coordinates for COF-108
calculated from Cerius² modeling.
COF-108

| Space group symmetry | P 4̅3m | | |
|---|---|---|---|
| a = b = c = 28.4410 Å | | | |
| α = β = γ = 90° | | | |
| Atom | x | y | z |
| O1 | 0.9154 | 0.1454 | 0.6714 |
| B1 | 0.8971 | 0.1029 | 0.6489 |
| C1 | 0.9226 | 0.0774 | 0.6070 |
| C2 | 0.9647 | 0.0953 | 0.5888 |
| C3 | 0.9886 | 0.0714 | 0.5531 |
| C4 | 0.9704 | 0.0296 | 0.5329 |
| C5 | 1.0000 | 0 | 0.5000 |
| C6 | 0.8489 | 0.7073 | 0.1172 |
| C7 | 0.8137 | 0.741 | 0.1166 |
| C6 | 0.8124 | 0.7769 | 0.1518 |

X-ray Data Collection, Unit Cell Determination, and Le Bail Extraction. Powder X-ray data were collected using a Bruker D8-Discover θ-2θ diffractometer in reflectance Bragg-Brentano geometry employing Ni filtered Cu Kα line focused radiation at 1600 W (40 kV, 40 mA) power and equipped with a Vantec Line detector. Radiation was focused using parallel focusing Gobel mirrors. The system was also outfitted with an anti-scattering shield which prevents incident diffuse radiation from hitting the detector, preventing the normally observed large background at 2□<3°. Samples were mounted on zero background sample holders by dropping powders from a wide-blade spatula and then leveling the sample surface with a razor blade. Given that the particle size of the ‘as synthesized’ samples were already found to be quite mono-disperse no sample grinding or sieving was used prior to analysis, however, the micron sized crystallites lead to peak broadening. The best counting statistics were achieved by collecting samples using a 0.02° 2□ step scan from 1.5-60° with an exposure time of 10 s per step. No peaks could be resolved from the baseline for 2□>35° therefore this region was not considered for further analysis.

Unit cell determinations were carried out using the Powder-X software suite (PowderX: Windows-95 based program for powder X-ray diffraction data processing) for peak selection and interfacing with the Treor (TREOR: A Semi-Exhaustive Trial-and-Error Powder Indexing Program for All Symmetries ab inito powder diffraction indexing program.

TABLE S5
Calculated and experimental unit cell parameters
for COF-102, COF-103, COF-105, and COF-108.

| | | | |
|---|---|---|---|
| Unit cell Parameter | Cerius² | Treor | Le Bail |

COF-102, Cubic, I 4̅3d

| | | | |
|---|---|---|---|
| a = b = c (Å) | 27.4081 | 28.00(9) | 27.177(1) |

COF-103, Cubic, I 4̅3d

| | | | |
|---|---|---|---|
| a = b = c (Å) | 28.4550 | 28.42(4) | 28.247(2) |

COF-105, Cubic, I 4̅3d

| | | | |
|---|---|---|---|
| a = b = c (Å) | 44.3818 | 45.1(8) | 44.886(5) |

COF-108, Cubic, P 4̅3m

| | | | |
|---|---|---|---|
| a = b = c (Å) | 28.4410 | 27.7(9) | 28.402(5) |

Le Bail extractions were conducted using the GSAS program using data up to 2θ=35 degrees. Backgrounds where hand fit with six terms applying a shifted Chebyschev Polynomial. Both profiles where calculated starting with the unit cell parameters indexed from the raw powder patterns and the atomic positions calculated from Cerius². Using the model-biased Le Bail algorithm, F_{obs} were extracted by first refining peak asymmetry with Gaussian peak profiles, followed by refinement of polarization with peak asymmetry. Unit cells were then refined with peak asymmetry and polarization resulting in convergent refinements. Once this was achieved unit cell parameters were refined followed by zero-shift. Refinement of unit cell parameters, peak asymmetry, polarization and zero-shift were used for the final profiles.

TABLE S6
Final statistics from Le Bail extractions of COF-102,
COF-103, COF-105, and COF-108 PXRD data.

| | COF-102 | COF-103 | COF-105 | COF-108 |
|---|---|---|---|---|
| Rₚ | 8.79 | 7.33 | 4.64 | 7.70 |
| wRₚ | 12.78 | 16.85 | 6.91 | 11.08 |
| χ² | 53.58 | 43.76 | 17.13 | 65.37 |

Full synthetic procedures for the preparation of COF-102, COF-103, COF-105, and COF-108. All starting materials and solvents, unless otherwise noted, were obtained from the Aldrich Chemical Co. and used with out further purification. Tetrahydrofuran was distilled from sodium benzophenone ketyl, acetone was distilled from anhydrous Ca(SO₄). Tetra(4-(dihydroxy)borylphenyl)silane and tetra(4-(dihydroxy)borylphenyl)methane were prepared according to literature method, COF-5 was prepared according to methods described by A. P. Côté et al. The isolation and handling of all products were performed under an inert atmosphere of nitrogen using either glovebox or Schlenk line techniques.

The low carbon values calculated for COF-102, -103, -105, and -108 is commonly encountered with organoboron compounds due to the formation of non-combustible boron carbide byproducts. Error in hydrogen elemental analysis data could be attributed to incomplete removal of solvents and starting materials from the pores.

Activation of COF-102 and COF-103 for gas adsorption measurements. Under an atmosphere of nitrogen, samples of COF-102 (65.0 mg) and COF-103 (65.0 mg) were loaded into a cylindrical quartz cells inside a glovebox then were heated to 60° C. under dynamic vacuum (1.0×10⁻⁵ Torr) for 12 h. The samples were back-filled with nitrogen to excluded adsorption of moisture prior Ar adsorption measurements.

FT-IR Spectroscopy of Starting Materials, Model Compounds, and COFs. FT-IR data was used to verify that the products were being produced. By observing the loss of certain stretches like hydroxyl groups expected for condensation reactions as well as the appearance of distinctive functional groups produced by the formation of boroxine and triboronate esters, the formation of the expected products can be confirmed. FT-IR spectra of starting materials, model compounds, and COFs were obtained as KBr pellets using Nicolet 400 Impact spectrometer.

Solid-State ¹¹B MQ/MAS, ¹³C CP/MAS, and ²⁹Si Nuclear Magnetic Resonance Studies for COF-102, COF-103, COF-105, and COF-108. High resolution solid-state nuclear magnetic resonance (NMR) spectra were recorded at ambient temperature on a Bruker DSX-300 spectrometer using a standard Bruker magic angle spinning (MAS) probe with 4 mm (outside diameter) zirconia rotors. Cross-polarization with MAS (CP/MAS) was used to acquire ¹³C data at 75.47 MHz. The ¹H and ¹³C ninety-degree pulse widths were both 4 μs. The CP contact time was 1.5 ms. High power two-pulse phase modulation (TPPM) ¹H decoupling was applied during data acquisition. The decoupling frequency corresponded to 72 kHz. The MAS sample spinning rate was 10 kHz. Recycle delays betweens scans varied between 10 and 30 s, depending upon the compound as determined by observing no apparent loss in the ¹³C signal intensity from one scan to the next. The ¹³C chemical shifts are given relative to tetramethylsilane as zero ppm, calibrated using the methine carbon signal of adamantane assigned to 29.46 ppm as a secondary reference.

CP/MAS was also used to acquire ²⁹Si data at 59.63 MHz. ¹H and ²⁹Si ninety-degree pulse widths of 4.2 μs were used with a CP contact time 7.5 ms. TPPM ¹H decoupling was applied during data acquisition. The decoupling frequency corresponded to 72 kHz. The MAS spinning rate was 5 kHz. Recycle delays determined from the ¹³C CP/MAS experiments were used for the various samples. The ²⁹Si chemical shifts are referenced to tetramethylsilane as zero ppm, calibrated using the trimethylsilyl silicon in tetrakis(trimethylsilyl)silane assigned to −9.8 ppm as a secondary reference.

Multiple quantum MAS (MQ/MAS) spectroscopy was used to acquire ¹¹B data at 96.29 MHz. The ¹¹B solution-state ninety-degree pulse width was 2 μs. TPPM ¹H decoupling was applied during data acquisition. The decoupling frequency corresponded to 72 kHz. The MAS spinning rate was 14.9 kHz. A recycle delay of 3 s was used. The ¹¹B chemical shifts are given relative to BF₃ etherate as zero ppm, calibrated using aqueous boric acid at pH=4.4 assigned to −19.6 ppm as a secondary reference.

Scanning Electron Microscopy Imaging (SEM) of COF-102, COF-103, COF-105, and COF-108. In order to determine the purity of products, SEM was used to scan for all types of morphologies present in the samples. Multiple samples of each COF material were subjected to scrutinization under the SEM microscope. Only one type of morphology was found to exist for each compound confirming the purity of the materials produced. Samples of all 3-D COFs were prepared by dispersing the material onto a sticky carbon surface attached to a flat aluminum sample holder. The samples were then gold coated using a Hummer 6.2 Sputter at 60 millitorr of pressure in an argon atmosphere for 45 seconds while maintaining 15 mA of current. Samples were analyzed on a JOEL JSM-6700 Scanning Electron Microscope using both the SEI and LEI detectors with accelerating voltages ranging from 1 kV to 15 kV.

Thermogravimetric Analysis: All the COF materials were analyzed by TGA to determine the thermal stability of the materials produced as well as confirm that all guest have been removed. Samples were run on a TA Instruments Q-500 series thermal gravimetric analyzer with samples held in platinum pans under atmosphere of nitrogen. A 5 K/min ramp rate was used.

Low Pressure (0-760 mTorr) Argon Adsorption Measurements for COF-102 and COF-103 at 87 K. The Pore Size Distribution of both compounds was calculated from these adsorption isotherms by the Non-Local Density Functional Theory (NLDFT) method using a cylindrical pore model.

Argon adsorption by COFs: Provided herein are porous Covalent Organic Frameworks (COFs) having functionalized pore and high surface area as adsorbents for Ar. In contrast to N₂, since Ar is inert molecule and spherical shape, these materials could be widely applicable to fundamental studies on Ar sorption mechanism.

The table below provides a list of COFs tested for Ar sorption:

| Material | | Metal | | |
|---|---|---|---|---|
| Codes | Structure | Ion | Linker | Composition |
| COF-102 | CTN | — | Tetra(4-dihydroxy- | C₂₅H₂₄B₄O₈ |
| | | | borylphenyl)methane | |
| COF-103 | CTN | — | Tetra(4-dihydroxy- | C₂₄H₂₄B₄O₈Si |
| | | | borylphenyl)silane | |

Sample Activation Procedures of COFs: General procedures: Low pressure Ar adsorption isotherms at 87° K. were measured volumetrically on an Autosorb-1 analyzer (Quantachrome Instruments).

Material: COF-102. The as-synthesized sample of COF-102 was immersed in anhydrous tetrahydrofuran in a glove box for 8 hours, during which the activation solvent was decanted and freshly replenished four times. The wet sample then was evacuated at ambient temperature for 12 hours to yield an activated sample for gas adsorption measurements. The sample cell with a filler rod was attached to a valve in a glove box, which was kept closing until the start of the measurement, and then attached to the instrument without exposing the sample to air.

Material: COF-103. The as-synthesized sample of COF-103 was immersed in anhydrous tetrahydrofuran in a glove box for 8 hours, during which the activation solvent was decanted and freshly replenished four times. The wet sample then was evacuated at ambient temperature for 12 hours to yield an activated sample for gas adsorption measurements. The sample cell with a filler rod was attached to a valve in a glove box, which was kept closing until the start of the measurement, and then attached to the instrument without exposing the sample to air.

Methane adsorption by COFs: Provided herein are Covalent Organic Frameworks (COFs) having functionalized pore, high surface area and thermal stability as adsorbents for reversible methane storage. Since a series of COFs contains large number of carbon atoms, it is expected that the ideal chemical composition promotes the strong interaction between methane and surface of COFs.

Three COFs were examined as candidates for CH₄ storage materials and gas separation adsorbents. Since these compounds possess various pore diameters and void space, systematic studies on CH₄ sorption behavior should be possible. Gas sorption isotherms were taken under high-pressure region (up to 85 bar) at 273 and 298° K.

The table below provides a list of COFs tested for methane sorption:

| Matl. | | | |
|---|---|---|---|
| Codes | Struc. | Linker | Composition |
| COF-8 | 2D | 1,3,5-tris[(p-boronic | C₁₄H₇BO₂ |
| | | acid)phenyl]benzene/Hexahydroxy | |
| | | triphenylene | |
| COF-10 | 2D | 4,4′-Biphenyldiboronic acid/ | C₁₂H₆BO₂ |
| | | Hexahydroxy triphenylene | |
| COF-102 | 3D | Tetra(4-dihydroxy- | C₂₅H₂₄B₄O₈ |
| | (ctn) | borylphenyl)methane | |

Sample Activation Procedures of COFs: General procedures: High-pressure CH₄ sorption isotherms were measured by the gravimetric method at 273 and 298° K. using a customized GHP-S-R instrument from the VTI Corporation. A Rubotherm magnetic suspension balance was used to measure the change in mass of samples. For buoyancy correction, the volume of the crystals was determined by the high-pressure helium isotherm.

Material: COF-8. The as-synthesized sample of COF-8 was immersed in anhydrous acetone in a glove box for 14 hours, during which the activation solvent was decanted and freshly replenished three times. The wet sample then was evacuated at 100° C. for 12 hours to yield an activated sample for gas adsorption measurements. The sample cell with a filler rod was attached to a valve in a glove box, which was kept closing until the start of the measurement, and then attached to the instrument without exposing the sample to air.

Material: COF-10. The as-synthesized sample of COF-10 was immersed in anhydrous acetone in a glove box for 14 hours, during which the activation solvent was decanted and freshly replenished three times. The wet sample then was evacuated at 100° C. for 10 hours to yield an activated sample for gas adsorption measurements. The sample cell with a filler rod was attached to a valve in a glove box, which was kept closing until the start of the measurement, and then attached to the instrument without exposing the sample to air.

Material: COF-102. The as-synthesized sample of COF-102 was immersed in anhydrous tetrahydrofuran in a glove box for 8 hours, during which the activation solvent was decanted and freshly replenished four times. The wet sample then was evacuated at ambient temperature for 12 hours to yield an activated sample for gas adsorption measurements. The sample cell with a filler rod was attached to a valve in a glove box, which was kept closing until the start of the measurement, and then attached to the instrument without exposing the sample to air.

CO₂ adsorption by COFs: Six COFs were examined as candidates for CO₂ storage materials and gas separation adsorbents. Since these compounds possess various pore diameters and functionalities, systematic studies on CO₂ sorption behavior should be possible. Gas sorption isotherms were taken under low pressure region (up to 760 Torr) at 273° K. and high-pressure region (up to 45 bar) at 273 and 298° K.

The ability of gas sorption has been examined by measuring CO₂ isotherms under wide range pressure. Some compounds showed high capacity rather than zeolite 13× and MAXSORB (carbon powder) which are widely used as adsorbents or separation agents.

The table below provides a list of COFs tested for carbon dioxide sorption:

| Matl. | | | |
|---|---|---|---|
| Codes | Struc. | Linker | Composition |
| COF-8 | 2D | 1,3,5-tris[(p-boronic | C₁₄H₇BO₂ |
| | | acid)phenyl]benzene/Hexahydroxy | |
| | | triphenylene | |
| COF-10 | 2D | 4,4′-Biphenyldiboronic acid/ | C₁₂H₆BO₂ |
| | | Hexahydroxy triphenylene | |
| COF-12 | 2D | 1,3,5-Triboronic acid/Hexahydroxy | C₈H₃BO₂ |
| | | triphenylene | |
| COF-14 | 2D | 1,3,5-Triboronic acid/ | C₅HBO₂ |
| | | Tetrahydroxybenzene | |
| COF-102 | ctn | Tetra(4-dihydroxy- | C₂₅H₂₄B₄O₈ |
| | | borylphenyl)methane | |
| COF-103 | ctn | Tetra(4-dihydroxy- | C₂₄H₂₄B₄O₈Si |
| | | borylphenyl)silane | |

Sample Activation Procedures of COFs: General procedures: Low pressure gas adsorption isotherms at 273° K. were measured volumetrically on an Autosorb-1 analyzer (Quantachrome Instruments). High-pressure CO₂ sorption isotherms were measured by the gravimetric method at 273° K. and 298° K. using a customized GHP-S-R instrument from the VTI Corporation. A Rubotherm magnetic suspension balance was used to measure the change in mass of samples. For buoyancy correction, the volume of the crystals was determined by the high-pressure helium isotherm.

Material: COF-8. The as-synthesized sample of COF-8 was immersed in anhydrous acetone in a glove box for 14 hours, during which the activation solvent was decanted and freshly replenished three times. The wet sample then was evacuated at 100° C. for 12 hours to yield an activated sample for gas adsorption measurements. The sample cell with a filler rod was attached to a valve in a glove box, which was kept closing until the start of the measurement, and then attached to the instrument without exposing the sample to air.

Material: COF-10. The as-synthesized sample of COF-10 was immersed in anhydrous acetone in a glove box for 14 hours, during which the activation solvent was decanted and freshly replenished three times. The wet sample then was evacuated at 100° C. for 10 hours to yield an activated sample for gas adsorption measurements. The sample cell with a filler rod was attached to a valve in a glove box, which was kept closing until the start of the measurement, and then attached to the instrument without exposing the sample to air.

Material: COF-12. The as-synthesized sample of COF-12 was immersed in anhydrous acetone in a glove box for 11 hours, during which the activation solvent was decanted and freshly replenished three times. The wet sample then was evacuated at 110° C. for 9 hours to yield an activated sample for gas adsorption measurements. The sample cell with a filler rod was attached to a valve in a glove box, which was kept closing until the start of the measurement, and then attached to the instrument without exposing the sample to air.

Material: COF-14. The as-synthesized sample of COF-14 was immersed in anhydrous acetone in a glove box for 10 hours, during which the activation solvent was decanted and freshly replenished three times. The wet sample then was evacuated at 100° C. for 8 hours to yield an activated sample for gas adsorption measurements. The sample cell with a filler rod was attached to a valve in a glove box, which was kept closing until the start of the measurement, and then attached to the instrument without exposing the sample to air.

Material: COF-102. The as-synthesized sample of COF-102 was immersed in anhydrous tetrahydrofuran in a glove box for 8 hours, during which the activation solvent was decanted and freshly replenished four times. The wet sample then was evacuated at ambient temperature for 12 hours to yield an activated sample for gas adsorption measurements. The sample cell with a filler rod was attached to a valve in a glove box, which was kept closing until the start of the measurement, and then attached to the instrument without exposing the sample to air.

Material: COF-103. The as-synthesized sample of COF-103 was immersed in anhydrous tetrahydrofuran in a glove box for 8 hours, during which the activation solvent was decanted and freshly replenished four times. The wet sample then was evacuated at ambient temperature for 12 hours to yield an activated sample for gas adsorption measurements. The sample cell with a filler rod was attached to a valve in a glove box, which was kept closing until the start of the measurement, and then attached to the instrument without exposing the sample to air.

Hydrogen adsorption by COFs: Six COFs were examined as candidates for H₂ storage materials. Since these compounds possess various pore diameters and functionalities, systematic studies on H₂ sorption behavior should be possible. Gas sorption isotherms were taken under low pressure region (up to 800 Torr) at 77 K and high-pressure region (up to 85 bar) at 77 and 298° K. Examined compounds are stable under high pressure atmosphere (up to 85 bar) and did not show significant drop of gas storage capacity with adsorption-desorption cycles.

The ability of gas sorption has been examined by measuring H₂ isotherms under wide range pressure. Some compound showed high capacity rather than zeolite 13× and activated carbon which are widely used as adsorbents or separation agents. Several materials are already synthesized in gram scale order successfully, leading that these materials can be tested as a practical phase.

The table below provides a list of COFs tested for hydrogen sorption:

| Matl. | | | |
|---|---|---|---|
| Codes | Struc. | Linker | Composition |
| COF-8 | 2D | 1,3,5-tris[(p-boronic | C₁₄H₇BO₂ |
| | | acid)phenyl]benzene/Hexahydroxy | |
| | | triphenylene | |
| COF-10 | 2D | 4,4′-Biphenyldiboronic acid/ | C₁₂H₆BO₂ |
| | | Hexahydroxy triphenylene | |
| COF-12 | 2D | 1,3,5-Triboronic acid/Hexahydroxy | C₈H₃BO₂ |
| | | triphenylene | |
| COF-14 | 2D | 1,3,5-Triboronic acid/ | C₅HBO₂ |
| | | Tetrahydroxybenzene | |
| COF-102 | ctn | Tetra(4-dihydroxy- | C₂₅H₂₄B₄O₈ |
| | | borylphenyl)methane | |
| COF-103 | ctn | Tetra(4-dihydroxy- | C₂₄H₂₄B₄O₈Si |
| | | borylphenyl)silane | |

General procedures: Low pressure H₂ adsorption isotherms at 273° K. were measured volumetrically on an Autosorb-1 analyzer (Quantachrome Instruments). High-pressure H₂ sorption isotherms were measured by the gravimetric method at 77 and 298° K. using a customized GHP-S-R instrument from the VTI Corporation. A Rubotherm magnetic suspension balance was used to measure the change in mass of samples. For buoyancy correction, the volume of the crystals was determined by the high-pressure helium isotherm.

Material: COF-8. The as-synthesized sample of COF-8 was immersed in anhydrous acetone in a glove box for 14 hours, during which the activation solvent was decanted and freshly replenished three times. The wet sample then was evacuated at 100° C. for 12 hours to yield an activated sample for gas adsorption measurements. The sample cell with a filler rod was attached to a valve in a glove box, which was kept closing until the start of the measurement, and then attached to the instrument without exposing the sample to air.

Material: COF-10. The as-synthesized sample of COF-10 was immersed in anhydrous acetone in a glove box for 14 hours, during which the activation solvent was decanted and freshly replenished three times. The wet sample then was evacuated at 100° C. for 10 hours to yield an activated sample for gas adsorption measurements. The sample cell with a filler rod was attached to a valve in a glove box, which was kept closing until the start of the measurement, and then attached to the instrument without exposing the sample to air.

Material: COF-12. The as-synthesized sample of COF-12 was immersed in anhydrous acetone in a glove box for 11 hours, during which the activation solvent was decanted and freshly replenished three times. The wet sample then was evacuated at 110° C. for 9 hours to yield an activated sample for gas adsorption measurements. The sample cell with a filler rod was attached to a valve in a glove box, which was kept closing until the start of the measurement, and then attached to the instrument without exposing the sample to air.

Material: COF-14. The as-synthesized sample of COF-14 was immersed in anhydrous acetone in a glove box for 10 hours, during which the activation solvent was decanted and freshly replenished three times. The wet sample then was evacuated at 100° C. for 8 hours to yield an activated sample for gas adsorption measurements. The sample cell with a filler rod was attached to a valve in a glove box, which was kept closing until the start of the measurement, and then attached to the instrument without exposing the sample to air.

Material: COF-102. The as-synthesized sample of COF-102 was immersed in anhydrous tetrahydrofuran in a glove box for 8 hours, during which the activation solvent was decanted and freshly replenished four times. The wet sample then was evacuated at ambient temperature for 12 hours to yield an activated sample for gas adsorption measurements. The sample cell with a filler rod was attached to a valve in a glove box, which was kept closing until the start of the measurement, and then attached to the instrument without exposing the sample to air.

Material: COF-103. The as-synthesized sample of COF-103 was immersed in anhydrous tetrahydrofuran in a glove box for 8 hours, during which the activation solvent was decanted and freshly replenished four times. The wet sample then was evacuated at ambient temperature for 12 hours to yield an activated sample for gas adsorption measurements. The sample cell with a filler rod was attached to a valve in a glove box, which was kept closing until the start of the measurement, and then attached to the instrument without exposing the sample to air.

Although a number of embodiments and features have been described above, it will be understood by those skilled in the art that modifications and variations of the described embodiments and features may be made without departing from the teachings of the disclosure or the scope of the subject matter as defined by the appended claims.

1. A covalent-organic framework (COF) comprising:
a plurality of organic multidentate cores, each organic multidentate core linked to at least one other organic multidentate core;
a plurality of linking clusters that connects adjacent organic multidentate cores, and
a plurality of pores, wherein the plurality of linked organic multidentate cores defines the plurality of pores.

2. A covalent-organic framework (COF) of claim 1, wherein the linking cluster comprising an identifiable association of 2 or more atoms, wherein the covalent bonds between each multidentate core and the linking cluster take place between atoms selected from carbon, boron, oxygen, nitrogen and phosphorus and at least one of the atoms connecting multidentate cores is an oxygen.

3. The COF of claim 1, wherein the organic multidentate core can covalently bond to 2, 3 or 4 multidentate linking clusters.

4-5. (canceled)

6. The COF of claim 1, wherein the multidentate linking cluster can covalently bond to 2, 3 or 4 multidentate cores.

7-8. (canceled)

9. A covalent organic framework (COF) comprising two or more frameworks of claim 1 covalently bonded to one another.

10. The COF of claim 9, wherein the frameworks are the same.

11. The COF of claim 9, wherein at least one of the frameworks is different from at least one other framework to which it is covalently bonded.

12. The COF of claim 1, wherein the plurality of multidentate cores are heterogeneous.

13. The COF of claim 1, wherein the plurality of linking clusters are heterogeneous.

14. The COF of claim 1, wherein the plurality of multidentate cores comprise alternating tetrahedral and triangular multidentate cores.

15. The COF of claim 1, wherein each of the plurality of pores comprises a sufficient number of accessible sites for atomic or molecular adsorption.

16. The COF of claim 15, wherein a surface area of a pore of the plurality of pores is greater than about 2000 m²/g.

17. The COF of claim 15, wherein a surface area of a pore of the plurality of pores is about 3,000-18,000 m²/g.

18. (canceled)

19. The COF of claim 1, wherein a pore of the plurality of pores comprises a pore volume 0.1 to 0.99 cm³/cm³.

20. (canceled)

21. The COF of claim 1, wherein the COF has a framework density of about 0.17 g/cm³.

22. The COF of claim 1, wherein the COF comprises atomic coordinates as set forth in Tables S1, S2, S3 or S4.

23. The COF of claim 1, wherein the linking cluster comprises a boron-containing linking cluster.

24. The COF of claim 1, further comprising a guest species.

25. The COF of claim 24, wherein the guest species increase the surface area of the COF.

26. The COF of claim 24, wherein the guest species is selected from the group consisting of organic molecules with a molecular weight less than 100 g/mol, organic molecules with a molecular weight less than 300 g/mol, organic molecules with a molecular weight less than 600 g/mol, organic molecules with a molecular weight greater than 600 g/mol, organic molecules containing at least one aromatic ring, polycyclic aromatic hydrocarbons, and metal complexes having formula MmXn where M is metal ion, X is selected from the group consisting of a Group 14 through Group 17 anion, m is an integer from 1 to 10, and n is a number selected to charge balance the metal cluster so that the metal cluster has a predetermined electric charge; and combinations thereof.

27. The COF of claim 1, further comprising an interpenetrating COF that increases the surface area of the framework.

28. The COF of claim 1, further comprising an adsorbed chemical species.

29. The COF of claim 28, wherein the adsorbed chemical species is selected from the group consisting of ammonia, carbon dioxide, carbon monoxide, hydrogen, amines, methane, oxygen, argon, nitrogen, argon, organic dyes, polycyclic organic molecules, and combinations thereof.

30. A covalent organic framework (COF) comprising
a plurality of organic multidentate cores;
a linking cluster;
wherein the linking cluster links at least two of the plurality of organic multidentate cores and wherein the COF comprises a pore volume about 0.4 to about 0.9 cm³/cm³, a pore surface area of about 2,900 m²/g to about 18,000 m²/g and a framework density of about 0.17 g/cm³.

31. A gas storage device comprising a COF of claim 1 or 30.

32. A device for the sorptive uptake of a chemical species, the device comprising a sorbent comprising a covalent-organic framework (COF) of claim 1 for the uptake of the chemical species.

33. The device of claim 32, wherein the uptake is reversible.

34. The device of claim 32, wherein the sorbent is comprised of discrete sorptive particles.

35. The device of claim 32, wherein the chemical species is in the form of a gas.

36. The device of claim 32, wherein the chemical species is in the form of a liquid.

37. The device of claim 32, wherein the device is a storage unit.

38. The device of claim 32, wherein the adsorbed chemical species is selected from the group consisting of ammonia, carbon dioxide, carbon monoxide, hydrogen, amines, methane, oxygen, argon, nitrogen, argon, organic dyes, polycyclic organic molecules, and combinations thereof.

39. A method for the sorptive uptake of a chemical species, the method comprising contacting the chemical species with a sorbent comprising a covalent-organic framework (COF) of claim 1.

40. The method of claim 39, wherein the uptake is reversible.

41. The method of claim 39, wherein the adsorbed chemical species is selected from the group consisting of ammonia, carbon dioxide, carbon monoxide, hydrogen, amines, methane, oxygen, argon, nitrogen, argon, organic dyes, polycyclic organic molecules, and combinations thereof.

42. The method of claim 39, wherein the uptake of a chemical species comprises storage of the chemical species.

43. The method of claim 42, wherein the chemical species is stored under conditions suitable for use as an energy source.

44. A method for the sorptive uptake of a chemical species, the method comprising contacting the chemical species with a device of claim 32.
